(19) United States
(12) Patent Application Publication
(10) Pub. No.: US 2014/0004458 A1
(43) Pub. Date: Jan. 2, 2014

(54) MAGENTA TONER

(71) Applicants: Yutaka Tani, Yokohama-shi (JP); Kaoru Takahashi, Saitama-shi (JP); Masao Nakano, Kamakura-shi (JP); Takayuki Ujifusa, Ashigarakami-gun (JP); Taichi Shintou, Saitama-shi (JP); Satoshi Saito, Mishima-shi (JP); Yasuaki Murai, Kawasaki-shi (JP); Kei Inoue, Yokohama-shi (JP); Takeshi Miyazaki, Ebina-shi (JP); Masashi Hirose, Machida-shi (JP)

(72) Inventors: Yutaka Tani, Yokohama-shi (JP); Kaoru Takahashi, Saitama-shi (JP); Masao Nakano, Kamakura-shi (JP); Takayuki Ujifusa, Ashigarakami-gun (JP); Taichi Shintou, Saitama-shi (JP); Satoshi Saito, Mishima-shi (JP); Yasuaki Murai, Kawasaki-shi (JP); Kei Inoue, Yokohama-shi (JP); Takeshi Miyazaki, Ebina-shi (JP); Masashi Hirose, Machida-shi (JP)

(73) Assignee: CANON KABUSHIKI KAISHA, Tokyo (JP)

(21) Appl. No.: 14/005,341

(22) PCT Filed: Mar. 9, 2012
(86) PCT No.: PCT/JP2012/056792

§ 371 Date: Sep. 16, 2013

(30) Foreign Application Priority Data
Mar. 17, 2011 (JP) 2011-059554

(51) Int. Cl. G03G 9/09

(52) U.S. Cl. CPC G03G 9/0906
USPC 430/108.21

(57) ABSTRACT

There is provided a magenta toner having spectral reflection characteristics, such as high color developability and transparency, and high lightfastness. The magenta toner contains at least a water-insoluble xanthene dye compound having a specific structure and a binder resin.

### TECHNICAL FIELD

The present invention relates to a magenta toner for use in image forming methods, such as electrophotography, electrostatic printing, and a toner jet method.

### BACKGROUND ART

In full-color digital copying machines and printers, colorants in developers significantly affect image quality. Thus, in the case where pigments are used as colorants, it is necessary to sufficiently pulverize pigments and uniformly disperse pigments in media.

Known examples of colorants for magenta toners among color toners include quinacridone pigments, thioindigo pigments, perylene pigments, diketopyrrolopyrrole pigments, xanthene dyes, and monoazo dyes and pigments.

Among these compounds, xanthene dyes serve as excellent colorants and have spectral characteristics, such as high color developability and transparency. Thus, xanthene dyes are suitably used for various applications (see PTLs 1 and 2).

### CITATION LIST

### Patent Literature

PTL 1 Japanese Patent Laid-Open No. 2009-080478
PTL 2 Japanese Patent Laid-Open No. 5-034980

### SUMMARY OF INVENTION

### Technical Problem

In the case where pigments are pulverized in order to improve the spectral characteristics, such as tinting power and transparency, of pigments, the application of heat and contact with solvents in a dispersion step and subsequent production steps lead to the growth, transition, and so forth of crystals, thereby disadvantageously causing problems, such as reductions in tinting power and transparency.

Meanwhile, xanthene dyes as described in PTLs 1 and 2 do not generally have sufficient lightfastness. Furthermore, in the case where xanthene dyes are used as colorants for magenta toners, the affinity for binder resins falls short of a satisfactory level.

Accordingly, aspects of the present invention solve the foregoing problems.

That is, aspects of the present invention provide a magenta toner having excellent color developability, transparency, and so forth, and high lightfastness.

### Solution to Problem

The present invention is described below.

That is, an aspect of the present invention provides a magenta toner containing at least a water-insoluble dye compound represented by formula (1) and a binder resin:

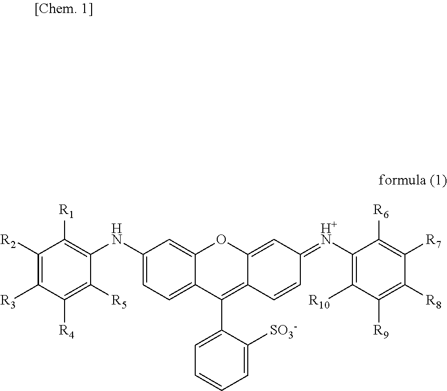

[wherein in formula (1), R₁, R₅, R₆, and R₁₀ each independently represent an alkyl group; R₃ and R₈ each independently represent a hydrogen atom, an alkyl group, an alkoxy group, or an aryloxy group; and R₂, R₄, R₇, and R₉ each independently represent a hydrogen atom or an acylamino group represented by formula (2), provided that at least one of R₂, R₄, R₇, and R₉ represents an acylamino group represented by formula (2):

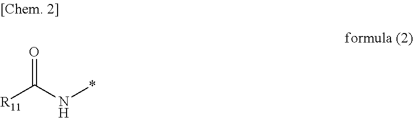

(wherein in formula (2), R₁₁ represents an alkyl group, a cycloalkyl group, an aryl group, an arylalkyl group, an alkenyl group, or a heterocyclic group; and * represents a binding site)].

### Advantageous Effects of Invention

Aspects of the present invention provide a magenta toner having spectral reflection characteristics, such as high color developability and transparency, and high lightfastness.

### BRIEF DESCRIPTION OF DRAWINGS

FIG. 1 is the ¹H-NMR spectrum of dye compound (5) according to aspects of the present invention at 400 MHz in DMSO-d₆ at 80° C.

FIG. 2 is the ¹H-NMR spectrum of dye compound (6) according to aspects of the present invention at 400 MHz in DMSO-d₆ at 80° C.

FIG. 3 is the ¹H-NMR spectrum of dye compound (7) according to aspects of the present invention at 400 MHz in DMSO-d₆ at 80° C.

FIG. 4 is the ¹H-NMR spectrum of dye compound (8) according to aspects of the present invention at 400 MHz in DMSO-d₆ at 80° C.

FIG. 5 is the ¹H-NMR spectrum of dye compound (10) according to aspects of the present invention at 400 MHz in DMSO-d₆ at 80° C.

FIG. 6 is the ¹H-NMR spectrum of dye compound (24) according to aspects of the present invention at 400 MHz in DMSO-d₆ at 80° C.

FIG. 7 is the ¹H-NMR spectrum of dye compound (25) according to aspects of the present invention at 400 MHz in DMSO-d₆ at 80° C.

### DESCRIPTION OF EMBODIMENTS

Aspects of the present invention will be described in detail below by embodiments. The inventors have conducted intensive studies to solve the foregoing problems of the related art and have found that the use of a water-insoluble dye compound represented by formula (1) as a colorant for a magenta toner provides a magenta toner having excellent color developability and transparency and high lightfastness. This finding has led to the completion of the present invention.

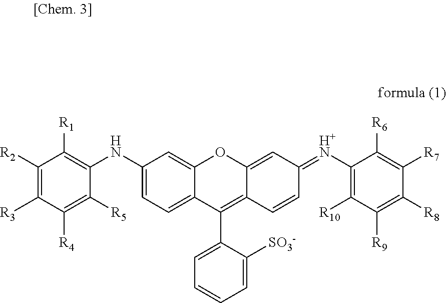

[wherein in formula (1), R₁, R₅, R₆, and R₁₀ each independently represent an alkyl group; R₃ and R₈ each independently represent a hydrogen atom, an alkyl group, an alkoxy group, or an aryloxy group; and R₂, R₄, R₇, and R₉ each independently represent a hydrogen atom or an acylamino group represented by formula (2), provided that at least one of R₂, R₄, R₇, and R₉ represents an acylamino group represented by formula (2):

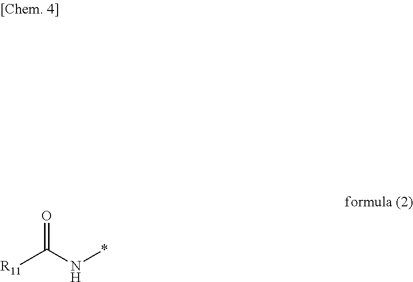

(wherein in formula (2), R₁₁ represents an alkyl group, a cycloalkyl group, an aryl group, an arylalkyl group, an alkenyl group, or a heterocyclic group; and * represents a binding site)].

The water-insoluble dye compound represented by formula (1) will be described below.

The water-insoluble dye compound represented by formula (1) has high affinity for an organic solvent. Note that the term “water-insoluble” used in aspects of the present invention indicates that the solubility in water is less than 1% by mass.

In formula (1), examples of the alkyl groups represented by R₁, R₅, R₆, and R₁₀ include methyl, ethyl, n-propyl, isopropyl, n-butyl, isobutyl, sec-butyl, and tert-butyl groups.

In formula (1), the alkyl group represented by each of R₁, R₅, R₆, and R₁₀ may be substituted with a substituent. Examples of the substituent that may be used include alkoxy groups, a cyano group, and halogen atoms. Specific examples of R₁, R₅, R₆, and R₁₀ having the substituents include hydroxyethyl, methoxyethyl, cyanoethyl, and trifluoromethyl groups.

In formula (1), R₁, R₅, R₆, and R₁₀ may be desirably selected from the functional groups listed above. In the case where R₁ and R₆ represent the same functional group and where R₅ and R₁₀ represent the same functional group, the water-insoluble dye compound may be easily produced. Furthermore, in the case where the functional groups each represent a methyl group, raw materials may be readily available.

In formula (1), examples of the alkyl groups represented by R₃ and R₈ include methyl, ethyl, n-propyl, isopropyl, n-butyl, isobutyl, sec-butyl, and tert-butyl groups.

In formula (1), examples of the alkoxy groups represented by R₃ and R₈ include methoxy, ethoxy, and isopropoxy groups.

In formula (1), examples of the aryloxy groups represented by R₃ and R₈ include phenoxy and naphthoxy groups.

In formula (1), the alkyl, alkoxy, and aryloxy groups represented by R₃ and R₈ may be substituted with a substituent. Examples of the substituent that may be used include alkyl, aryl, arylalkyl, hydroxy, carbamoyl, sulfamoyl, alkoxy, and cyano groups, and halogen atoms. Specific examples of R₃ and R₈ having the substituents include hydroxyethyl, methoxyethyl, cyanoethyl, trifluoromethyl, methoxyethoxy, hydroxyethoxy, p-methoxyphenoxy, o-methoxyphenoxy, tolyloxy, and xylyloxy groups.

In formula (1), each of R₃ and R₈ may be desirably selected from the functional groups listed above and a hydrogen atom. In the case where R₃ and R₈ each represent a methyl group, an ethyl group, or a propyl group, satisfactory lightfastness may be provided. In the case where R₃ and R₈ each represent a group other than a hydrogen atom, R₃ and R₈ may represent the same functional group in view of the ease of production.

In formula (1), R₂, R₄, R₇, and R₉ each independently represent a hydrogen atom or the acylamino group represented by formula (2). At least one of R₂, R₄, R₇, and R₉ represents the acylamino group represented by formula (2). To provide the water-insoluble dye compound having high color developability and high lightfastness, at least one of R₂, R₄, R₇, and R₉ needs to represent the acylamino group represented by formula (2).

In particular, each of two to four of R₂, R₄, R₇, and R₉ in formula (1) may represent the acylamino group represented by formula (2) from the viewpoint of enhancing color developability and lightfastness. In this case, the acylamino groups may be identical with each other in view of the ease of production. Furthermore, R₂ and R₇ in formula (1) may represent the same functional group, and R₄ and R₉ in formula (1) may represent the same functional group.

In formula (2), examples of the alkyl group represented by R₁₁ include methyl, ethyl, n-propyl, isopropyl, n-butyl, isobutyl, sec-butyl, and tert-butyl groups.

In formula (2), examples of the cycloalkyl group represented by R₁₁ include cyclopentyl, cyclohexyl, and cycloheptyl groups.

In formula (2), an example of the aryl group represented by R₁₁ is a phenyl group.

In formula (2), examples of the arylalkyl group represented by R₁₁ include a benzyl group and 2-phenethyl group.

In formula (2), examples of the alkenyl group represented by R₁₁ include vinyl, 1-propenyl, 2-propenyl, 1-methylethenyl, 1-butenyl, 2-butenyl, and 3-butenyl groups.

In formula (2), examples of the heterocyclic group represented by R₁₁ include imidazolyl, benzoimidazolyl, pyrazolyl, benzopyrazolyl, triazolyl, thiazolyl, benzothiazolyl, isothiazolyl, benzoisothiazolyl, oxazolyl, benzoxazolyl, thiadiazolyl, pyrrolyl, benzopyrrolyl, indolyl, isoxazolyl, benzoisoxazolyl, thienyl, benzothienyl, furyl, benzofuryl, pyridyl, quinolyl, isoquinolyl, pyridazinyl, pyrimidinyl, pyrazinyl, cinnolinyl, phthalazinyl, quinazolinyl, quinoxalinyl, and triazinyl groups.

The functional group represented by R₁₁ in formula (2) may be substituted with a substituent. Examples of the substituent that may be used include alkyl, aryl, arylalkyl, alkenyl, alkoxy, cyano, alkylamino, sulfoalkyl, carbamoyl, sulfamoyl, and sulfonylamino groups, and halogen atoms. Specific examples of R₁₁ having the substituent include hydroxyethyl, methoxyethyl, cyanoethyl, trifluoromethyl, p-tolyl, p-methoxyphenyl, and o-chlorophenyl groups.

In formula (2), R₁₁ may be desirably selected from the functional groups listed above. R₁₁ may represent an alkyl group, a cycloalkyl group, an aryl group, or an arylalkyl group in view of color developability. R₁₁ may represent an alkyl group or an aryl group in view of the ease of production. R₁₁ may represent a linear alkyl group in view of better lightfastness.

For the water-insoluble dye compound represented by formula (1), as illustrated in the following drawing, tautomers represented by, for example, formulae (3) and (4), are present. These tautomers are also within the scope of the present invention.

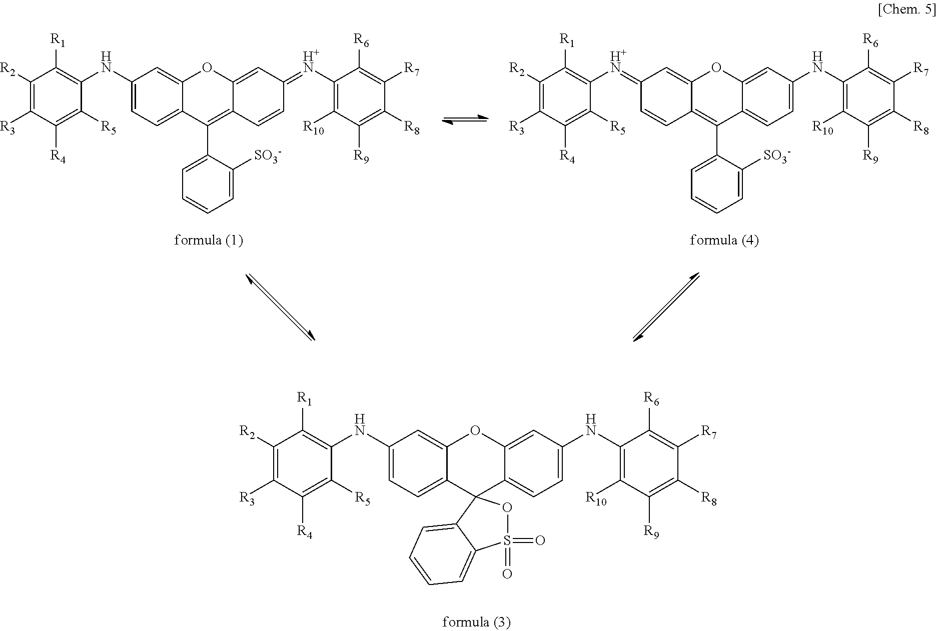

In formulae (3) and (4), R₁ to R₁₀ are defined the same as R₁ to R₁₀ in formula (1).

The water-insoluble dye compound represented by formula (1) may be synthesized according to a known production method. An exemplary synthetic scheme will be illustrated below.

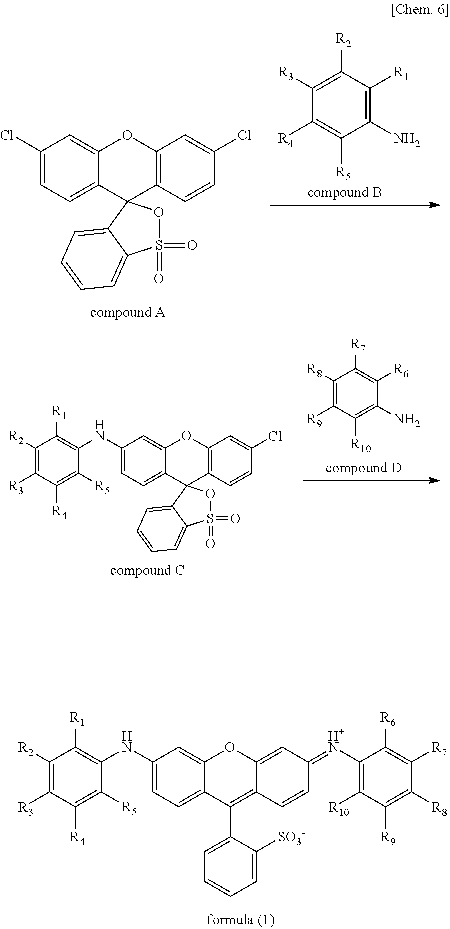

In compounds B, C, and D described above, R₁ to R₁₀ are defined the same as R₁ to R₁₀ in formula (1).

In the scheme exemplified above, the water-insoluble dye compound represented by formula (1) is synthesized by a first condensation step illustrated in the first row and a second condensation step illustrated in the second row.

In the first condensation step, compound A and compound B are heated and condensed in the presence or absence of an organic solvent and a condensing agent to synthesize compound C. As illustrated in the second row, compound C synthesized in the first condensation step and compound D are heated and condensed to give the water-insoluble dye compound represented by formula (1).

Compounds B and C, which are aniline derivatives, and compound A are readily commercially available and can be easily synthesized by known methods.

The organic solvent used for the condensation reaction in the synthetic scheme illustrated above will be described below. The organic solvent that may be used in the step is not particularly limited as long as the organic solvent does not participate in the reaction. Examples thereof include methanol, ethanol, n-propanol, isopropyl alcohol, n-butanol, toluene, xylene, ethylene glycol, N-methylpyrrolidone, N,N-dimethylacetamide, N,N-dimethylformamide, dimethyl sulfoxide, sulfolane, chlorobenzene, dichlorobenzene, trichlorobenzene, and nitrobenzene. These compounds may be used separately or in combination of two or more, depending on the solubility of the substrate.

Examples of the condensing agent used in the step include magnesium oxide, zinc chloride, and aluminum chloride.

The steps are usually performed in the temperature range of 60° C. to 220° C. and usually completed within 24 hours.

The reaction temperature in the first condensation step is preferably in the range of 60° C. to 100° C. and more preferably 70° C. to 90° C. In this range, the reaction rate is appropriate, and an excessive reaction is inhibited, thus facilitating purification. The reaction temperature in the second condensation step is preferably in the range of 120° C. to 220° C. and more preferably 180° C. or lower. In this range, the reaction rate is appropriate, and the decomposition of the formed compound is satisfactorily inhibited.

In the case of synthesizing the water-insoluble dye compound in which R₁ to R₅ represent the same functional group and in which R₆ to R₁₀ represent the same functional group in formula (1), compounds B and D in the scheme may be the same compound. Accordingly, in this case, the water-insoluble dye compound represented by formula (1) may be synthesized by a single condensation step from compound A. The reaction is usually performed at 100° C. to 220° C. and usually completed within 24 hours.

An end product synthesized by the foregoing reaction scheme is treated according to a common post-treatment for an organic synthesis reaction and then is subjected to purification, for example, recrystallization, reprecipitation, or column chromatography, to give a high-purity dye compound. The water-insoluble dye compound represented by formula (1) may be identified by, for example, ¹H-nuclear magnetic resonance spectroscopy, LC/TOF MS, and UV/Vis spectrophotometry.

The water-insoluble dye compound represented by formula (1) may be used alone for a colorant. Two or more water-insoluble dye compounds represented by formula (1) may be used in combination of two or more, as needed. Alternatively, the water-insoluble dye compound represented by formula (1) may be used in combination with a known magenta pigment or dye. Furthermore, the water-insoluble dye compound represented by formula (1) may be used as a lake pigment.

A magenta toner according to aspects of the present invention will be described below.

A magenta toner according to aspects of the present invention contains a binder resin and the water-insoluble dye compound represented by formula (1) and may contain wax, a charge control agent, and so forth, as needed.

Examples of the binder resin include homopolymers of polymerizable vinyl monomers, such as styrene monomers, e.g., styrene, α-methylstyrene, α-ethylstyrene, o-methylstyrene, m-methylstyrene, p-methylstyrene, o-ethylstyrene, m-ethylstyrene, and p-ethylstyrene, methacrylic acid derivative monomers, e.g., methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, methacrylamide, N-methylmethacrylamide, N,N-dimethylmethacrylamide, and N-(3-dimethylaminopropyl)methacrylamide, acrylic acid derivative monomers, e.g., methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, acrylamide, N-methylacrylamide, N,N-dimethylacrylamide, N-ethylacrylamide, N-(hydroxymethyl)acrylamide, and N-(hydroxyethyl)acrylamide, and olefin monomers, e.g., butadiene, isoprene, and cyclohexene; copolymers prepared by combinations of two or more thereof; and mixtures of the homopolymers and the copolymers. Further examples thereof include epoxy resins, polyester resins, polyurethane resins, polyamide resins, cellulose resins, polyether resins and non-vinyl condensed resins; mixtures of these resins and the vinyl resins described above; and graft polymers prepared by the polymerization of vinyl monomers in the presence thereof.

The binder resin may be used alone. Alternatively, in general, the monomers may be appropriately mixed with each other and used in such a manner that a theoretical glass transition temperature (Tg) (described in J. Brandrup, and E. H. Immergut, Eds.; “Polymer Handbook”, Third edition; John Wiley & Sons, U.S.A., 1989; pp 209-277) is in the range of 40° C. to 75° C. In the case where the theoretical glass transition temperature is within the above range, image transparency is maintained while storage stability and stability when a large number of sheets are printed are satisfactorily maintained.

Specific examples of the wax include petroleum waxes, such as paraffin waxes, microcrystalline waxes, and petrolatum, and derivatives thereof; montan waxes and derivatives thereof; hydrocarbon waxes synthesized by the Fischer-Tropsch process, and derivatives thereof; polyolefin waxes, such as polyethylene waxes, and derivatives thereof; and natural waxes, such as carnauba waxes and candelilla waxes, and derivatives thereof. The derivatives include their oxides, their block copolymers with vinyl monomers, and graft-modified products. Further examples of the wax include alcohols, such as higher aliphatic alcohols; fatty acids, such as stearic acid and palmitic acid; fatty acid amides; fatty acid esters; castor oil and derivatives thereof; plant waxes; and animal waxes. These waxes may be used separately or in combination of two or more, as needed.

The wax preferably has a melting point of 50° C. to 200° C. and more preferably 50° C. to 150° C. The term “melting point” used in aspects of the present invention indicates the peak temperature of a main endothermic peak in a curve measured by differential scanning calorimetry (DSC) according to ASTM D3418-82. Specifically, the melting point of the wax is determined as follows: Measurement is performed with a differential scanning calorimeter (DSC822, manufactured by Mettler Toledo International Inc.) in the measurement temperature range of 30° C. to 200° C. at a heating rate of 5° C./min. A second temperature raising process is performed under normal temperature and normal humidity conditions to obtain a DSC curve in the temperature range of 30° C. to 200° C. The peak temperature of a main endothermic peak in the DSC curve is defined as the melting point.

The wax content is preferably in the range of 1 to 25 parts by mass and more preferably 3 to 20 parts by mass with respect to 100 parts by mass of the binder resin.

While the dye compound represented by formula (1) is used as a colorant contained in base toner particles in the magenta toner according to aspects of the present invention, an additional colorant may be combined therewith, as needed.

Examples of the additional colorant that may be combined include condensed azo compounds, azo metal complexes, diketopyrrolopyrrole compounds, anthraquinone compounds, quinacridone compounds, basic dye lake compounds, naphthol compounds, benzimidazolone compounds, thioindigo compounds, perylene compounds, methine compounds, and allylamide compounds. Specific examples thereof include, but are not limited to, C.I. Pigment Orange 1, 5, 13, 15, 16, 34, 36, 38, 62, 64, 67, 72, and 74; C.I. Pigment Red 2, 3, 4, 5, 6, 7, 12, 16, 17, 23, 31, 32, 41, 48, 48:1, 48:2, 48:3, 48:4, 53:1, 57:1, 81:1, 112, 122, 123, 130, 144, 146, 149, 150, 166, 168, 169, 170, 176, 177, 178, 179, 181, 184, 185, 187, 190, 194, 202, 206, 208, 209, 210, 220, 221, 224, 238, 242, 245, 253, 254, 255, 258, 266, 269, and 282; C.I. Pigment Violet 13, 19, 25, 32, and 50; and various colorants classified as derivatives thereof.

The total colorant content may be in the range of 1 to 20 parts by mass with respect to 100 parts by mass of the binder resin.

The magenta toner according to aspects of the present invention may contain a charge control agent, as needed. This makes it possible to optimally control the degree of triboelectric charging in response to a development system.

Any known charge control agent may be used as the charge control agent used for the base toner particles in the magenta toner according to aspects of the present invention. In particular, a charge control agent which has a triboelectric charging speed and which is capable of stably maintaining a certain amount of triboelectric charge may be used in view of high-speed developability and image stability. In the case where the toner is produced by direct polymerization, a charge control agent which has a low degree of inhibition of polymerization and which does not substantially contain a component soluble in an aqueous dispersion medium may be used.

Examples of a charge control agent that permits the toner to be negatively chargeable include polymers and copolymers each containing a sulfonic acid group, a sulfonate group, or a sulfonic acid ester group; salicylic acid derivatives and metal complexes thereof; monoazo metal compounds; metal acetylacetonate compounds; aromatic oxycarboxylic acids; aromatic mono- and poly-carboxylic acids and metal salts thereof, anhydrides thereof, and esters thereof; phenol derivatives, such as bisphenols; urea derivatives; metal-containing naphthoic acid compounds; boron compounds; quaternary ammonium salts; calixarenes; and resin-based charge control agents.

Examples of a charge control agent that permits the toner to be positively chargeable include nigrosine and modified nigrosine with, for example, metal salts of fatty acids; guanidine compounds; imidazole compounds; onium salts, such as quaternary ammonium salts, e.g., tributylbenzylammonium 1-hydroxy-4-naphthosulfonate and tetrabutylammonium tetrafluoroborate, and their phosphonium salt analogues, and lake pigments thereof; triphenylmethane dyes and lake pigments thereof (examples of a laking agent include phosphotungstic acid, phosphomolybdic acid, phosphotungstomolybdic acid, tannic acid, lauric acid, gallic acid, ferricyanide, and ferrocyanide); metal salts of higher fatty acids; diorganotin oxides, such as dibutyltin oxide, dioctyltin oxide, and dicyclohexyltin oxide; diorganotin borates, such as dibutyltin borate, dioctyltin borate, and dicyclohexyltin borate; and resin-based charge control agents.

Among these charge control agents, two or more agents may be combined.

The toner according to aspects of the present invention may be a magnetic toner or a non-magnetic toner. In the case where the toner according to aspects of the present invention is used as a magnetic toner, a known magnetic material may be incorporated.

In the magenta toner according to aspects of the present invention, external additives, such as a fine inorganic powder and fine resin particles, may be added to surfaces of the base toner particles containing the binder resin and the colorant. Examples of the fine inorganic powder include fine powders composed of silica, titanium oxide, alumina, and double oxides thereof, and powders produced by subjecting these fine powders to surface treatment. Examples of the fine resin particles include fine particles composed of vinyl resins, polyester resins, and silicone resins. They function to increase flowability.

Examples of a method for producing the magenta toner according to aspects of the present invention include a suspension polymerization method, an emulsion aggregation method, a suspension granulation method, an emulsion polymerization method, and a grinding method, which are known methods. Among these production methods, in particular, production methods, such as the suspension polymerization method, the emulsion aggregation method, and the suspension granulation method, in which granulation is performed in an aqueous medium, may be employed from the viewpoint of achieving low environmental load and good controllability of the particle size during the production.

The methods for producing the toner will be described below.

First, the production of a toner by the suspension polymerization method will be described below.

In the case where the magenta toner is produced by the suspension polymerization method, a dispersion step of producing what is called a masterbatch in which a colorant containing the dye compound represented by formula (1) is dispersed or dissolved in a medium in advance may be performed from the viewpoint of improving the dispersibility of the colorant in the toner.

For example, the masterbatch is prepared as follows: The colorant containing the water-insoluble dye compound represented by formula (1), and, for example, a resin, as needed, are gradually added under stirring to a dispersion medium in which the colorant is to be dispersed, thereby allowing the components to be sufficiently mixed with the dispersion medium. Then the application of a mechanical shearing force to the mixture with a disperser allows the colorant to be stably dissolved or finely dispersed.

The dispersion medium that may be used for the masterbatch is not particularly limited. To effectively provide the solubility and dispersibility of the colorant, the dispersion medium may be a water-insoluble solvent. Specific examples of the water-insoluble solvent include esters, such as methyl acetate, ethyl acetate, and propyl acetate; aliphatic hydrocarbons, such as hexane, octane, petroleum ether, and cyclohexane; aromatic hydrocarbons, such as benzene, toluene, and xylene; and halogen-containing hydrocarbons, such as carbon tetrachloride, trichloroethylene, and tetrabromoethane.

The dispersion medium used for the masterbatch may also be a polymerizable monomer. The polymerizable monomer is an addition polymerizable or condensation polymerizable monomer and may be an addition polymerizable monomer. Specific examples thereof include styrene monomers, such as styrene, α-methylstyrene, α-ethylstyrene, o-methylstyrene, m-methylstyrene, p-methylstyrene, o-ethylstyrene, m-ethylstyrene, and p-ethylstyrene; methacrylic acid derivative monomers, such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, methacrylamide, N-methylmethacrylamide, N,N-dimethylmethacrylamide, and N-(3-dimethylaminopropyl)methacrylamide; acrylic acid derivative monomers, such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, acrylamide, N-methylacrylamide, N,N-dimethylacrylamide, N-ethylacrylamide, N-(hydroxymethyl)acrylamide, and N-(hydroxyethyl)acrylamide; and olefin monomers, such as butadiene, isoprene, and cyclohexene.

A resin may also be added to the masterbatch, as needed. As the resin that may be added to the masterbatch, a resin that may be used as the binder resin may be used. Specific examples thereof include polystyrene resins, styrene copolymers, polyacrylic acid resins, polymethacrylic acid resins, polyacrylate resins, polymethacrylate resins, acrylic acid copolymers, methacrylic acid copolymers, polyvinyl ether resins, polyvinyl methyl ether resins, polyvinyl alcohol resins, and polyvinyl butyral resins. These resins may be used separately or in combination of two or more, as needed.

The masterbatch may further contain an auxiliary agent, as needed. Specific examples thereof include surfactants, pigment dispersers and non-pigment dispersers, fillers, standardizers, antifoaming agents, antistatic agents, dust control agents, bulking agents, shading colorants, preservatives, drying retarders, rheology control additives, humectants, antioxidants, UV absorbers, light stabilizers, and combinations thereof.

After the preparation of the masterbatch, the remaining polymerizable monomer, wax, and so forth are added thereto to prepare a polymerizable monomer composition. A polar resin, for example, a polyester resin or polycarbonate resin, may be added to the polymerizable monomer composition. The polar resin added forms thin films on surfaces of the base toner particles or is present in a concentration gradient from the surface of each of the base toner particles toward the center, depending on a polar balance between the polymerizable monomer composition and the aqueous dispersion medium. Furthermore, the use of a polar resin that interacts with the colorant according to aspects of the present invention makes it possible to adjust the state of the colorant present in the toner.

In the magenta toner prepared by the suspension polymerization method, a crosslinking agent may be used in the synthesis of the binder resin in order to increase the mechanical strength of the toner and regulate the molecular weight of the binder resin.

Examples of the crosslinking agent include, but are not particularly limited to, bifunctional crosslinking agents, such as divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester acrylates, ethylene glycol dimethacrylate, 1,3-butylene glycol dimethacrylate, 1,4-butanediol dimethacrylate, 1,5-pentanediol dimethacrylate, 1,6-hexanediol dimethacrylate, neopentyl glycol dimethacrylate, diethylene glycol dimethacrylate, triethylene glycol dimethacrylate, tetraethylene glycol dimethacrylate, dimethacrylates of polyethylene glycols #200, #400, and #600, dipropylene glycol dimethacrylate, polypropylene glycol dimethacrylates, and polyester dimethacrylates.

Examples of a polyfunctional crosslinking agent include, but are not particularly limited to, pentaerythritol triacrylate, trimethylolethane triacrylate, trimethylolpropane triacrylate, tetramethylolmethane tetraacrylate, oligoester acrylate, pentaerythritol trimethacrylate, trimethylolethane trimethacrylate, trimethylolpropane trimethacrylate, tetramethylolmethane tetramethacrylate, oligoester methacrylate, 2,2-bis(4-methacryloxyphenyl)propane, diallyl phthalate, triallyl cyanurate, triallyl isocyanurate, and triallyl trimellitate.

These crosslinking agents are each preferably used in an amount of 0.05 to 10 parts by mass and more preferably 0.1 to 5 parts by mass with respect to 100 parts by mass of the polymerizable monomer in view of the fixability of the toner and offset resistance.

Examples of the disperser that may be used in this process include, but are not particularly limited to, rotary-shear homogenizers, media-type dispersers, e.g., ball mills, sand mills, and attritors, and high-pressure counter collision-type dispersers.

The polymerizable monomer composition is dispersed in the aqueous medium and granulated to form droplets of the polymerizable monomer composition. The polymerizable monomer in the droplets is polymerized in the aqueous medium using a polymerization initiator to prepare a suspension containing toner particles. The toner particles are then separated from the suspension containing the toner particles. The separated toner particles are washed and dried.

Examples of the polymerization initiator include known polymerization initiators. Specific examples thereof include azo compounds, organic peroxides, inorganic peroxides, organometallic compounds, and photopolymerization initiators. More specific examples thereof include azo compounds, such as 2,2′-azobis(isobutyronitrile), 2,2′-azobis(2-methylbutyronitrile), 2,2′-azobis(4-methoxy-2,4-dimethylvaleronitrile), 2,2′-azobis(2,4-dimethylvaleronitrile), and dimethyl 2,2′-azobis(isobutyrate); organic peroxide polymerization initiators, such as benzoyl peroxide, di-tert-butyl peroxide, tert-butylperoxyisopropyl monocarbonate, tert-hexylperoxy benzoate, and tert-butylperoxy benzoate; inorganic peroxide polymerization initiators, such as potassium persulfate and ammonium persulfate; and redox initiators, such as a hydrogen peroxide-ferrous system, a BPO-dimethylaniline system, and cerium(IV) salt-alcohol system. Examples of the photopolymerization initiator include acetophenones, benzoin ethers, and ketals.

The amount of the polymerization initiators used is preferably in the range of 0.1 to 20 parts by mass and more preferably 0.1 to 10 parts by mass with respect to 100 parts by mass of the polymerizable monomer in view of the degree of polymerization. The type of polymerization initiator varies slightly depending on the polymerization method. These polymerization initiators may be used separately or in combination of two or more, as needed, with reference to their 10-hour half-life temperatures.

The aqueous medium used in the suspension polymerization method may contain a dispersion stabilizer from the viewpoint of achieving satisfactory stability of the polymerizable monomer composition. Examples of the dispersion stabilizer that may be used include known inorganic and organic dispersion stabilizers.

Among the dispersion stabilizers described above, in aspects of the present invention, a poorly water-soluble inorganic dispersion stabilizer that is soluble in an acid may be used in view of the removal of the dispersion stabilizer in the subsequent washing step. In aspects of the present invention, in the case where the poorly water-soluble inorganic dispersion stabilizer is used to prepare the aqueous dispersion medium, the dispersion stabilizer may be used in an amount of 0.2 to 2.0 parts by mass with respect to 100 parts by mass of the polymerizable monomer in view of the stability of the droplets of the polymerizable monomer composition in the aqueous medium. The aqueous medium may be prepared using 300 to 3000 parts by mass of water with respect to 100 parts by mass of the polymerizable monomer composition in view of the stability of the droplets.

In the suspension polymerization method, a method for dispersing the polymerizable monomer composition in the aqueous medium and granulating the droplets of the polymerizable monomer composition is not particularly limited. For example, a known method using a rotary-shear homogenizer, a high-pressure counter collision-type disperser, an ultrasonic disperser, or the like may be employed.

A washing procedure in the washing step is not particularly limited but includes subjecting the suspension containing the toner particles to solid-liquid separation by filtration, washing the resulting solid with distilled water under stirring, and filtering the mixture. The washing may be repeated until the electrical conductivity of the filtrate reaches 150 μS/cm or less, from the viewpoint of achieving satisfactory toner chargeability.

In the drying step, commonly known methods, such as a vibration-type fluidization drying method, a spray-drying method, a freeze-drying method, and a flash jet method, may be employed. The base toner particles after drying preferably have a water content of 1.5% by mass or less and more preferably 1.0% by mass in view of chargeability.

Next, the production of a toner by the emulsion aggregation method will be described.

First, a resin particle dispersion that contains resin particles dispersed in an aqueous medium, and a colorant particle dispersion that contains colorant particles containing the water-insoluble dye compound represented by formula (1) are dispersed in an aqueous medium are prepared. Furthermore, a wax particle dispersion that contains wax particles dispersed in an aqueous medium is prepared, as needed. The resulting dispersions are mixed together to prepare a mixture (dispersion step). Then particles contained in the mixture prepared in the foregoing step are aggregated into aggregated particles (aggregation step). The aggregated particles are heated to coalesce (coalescence step). The coalescent particles are filtered, washed, and dried into a toner.

The term “aqueous medium” used in the dispersion step indicates a medium mainly containing water. Specific examples of the aqueous medium include water, a medium containing water and a pH adjusting agent, and a medium containing water and an organic solvent.

A resin constituting the resin particles in the resin particle dispersion is not particularly limited as long as the resin is suitable for the binder resin for the toner.

The resin particle dispersion is prepared by a known method. For example, in the case of a resin particle dispersion containing resin particles made from a vinyl monomer, in particular, a styrene monomer, the resin particle dispersion may be prepared by emulsion polymerization of the monomer in the presence of a surfactant.

In the case of a resin (e.g., a polyester resin) prepared by another method, the resin is dissolved in a lipophilic solvent having a relatively low solubility in water to prepare a resin solution. The resulting resin solution is added to an aqueous medium together with an ionic surfactant and a polyelectrolyte. Fine droplets of the resin solution are formed with a disperser, such as a homogenizer. The evaporation of the solvent under heat or reduced pressure provides the resin particle dispersion. Alternatively, a resin particle dispersion may be prepared by, for example, a method that includes adding a surfactant to a resin and emulsifying and dispersing the resulting mixture in water with a disperser such as a homogenizer, or a phase inversion emulsification method.

The resin particles in the resin particle dispersion preferably have a median size of 0.005 to 1.0 μm and more preferably 0.01 to 0.4 μm on a volume basis in view of the aggregability of the particles and the granulation properties of the toner particles.

The average particle size of the resin particles may be measured by, for example, a dynamic light scattering (DLS) method, a laser scattering method, a centrifugal sedimentation method, a field-flow fractionation method, or an electric detector method. The term “average particle size” used in aspects of the present invention indicates a 50% cumulative particle size (D50), on a volume basis, measured by the dynamic light scattering (DLS) method or a laser Doppler method at 20° C. and a solid content of 0.01% by mass as described below, unless otherwise specified.

Furthermore, the resin particle dispersion containing the colorant may be prepared by simultaneously feeding the binder resin and the colorant together into an aqueous medium and dispersing the binder resin and the colorant in the aqueous medium.

The colorant particle dispersion may contain a surfactant in order to stabilize the dispersion of the colorant particles. Examples of the surfactant include water-soluble polymers, inorganic compounds, and ionic or nonionic surfactants. An ionic surfactant, in particular, an anionic surfactant, may be used in view of their surface activity.

The surfactant preferably has a molecular weight of 10,000 or less and more preferably 5,000 or less in view of its washability in a downstream step. Meanwhile, the surfactant preferably has a molecular weight of 100 or more and more preferably 200 or more in view of its surface activity.

Specific examples of the surfactant include water-soluble polymers, such as polyvinyl alcohol, methyl cellulose, carboxymethyl cellulose, and sodium polyacrylate; anionic surfactants, such as sodium dodecylbenzenesulfonate, sodium octadecyl sulfate, sodium oleate, sodium laurate, and potassium stearate; cationic surfactants, such as laurylamine acetate, and lauryltrimethylammonium chloride; ampholytic surfactants, such as lauryldimethylamine oxide; nonionic surfactants, such as polyoxyethylene alkyl ether, polyoxyethylene alkylphenyl ether, and polyoxyethylene alkylamine; and inorganic compounds, such as tricalcium phosphate, aluminum hydroxide, calcium sulfate, calcium carbonate, and barium carbonate. These compounds may be used separately or in combination of two or more, as needed.

The amount of the surfactant used is in the range of 0.01 to 10 parts by mass, preferably 0.1 to 5.0 parts by mass, and more preferably 0.5 to 3.0 parts by mass with respect to 100 parts by mass of the colorant in view of the washability in the downstream step.

The colorant particle dispersion is prepared by a known method. For example, a rotary-shear homogenizer, a media-type disperser, such as a ball mill, a sand mill, and an attritor, a high-pressure counter collision-type disperser, or the like may be used.

The wax dispersion used in the dispersion step is prepared by a known method.

The resin particle dispersion, the colorant particle dispersion, and the wax dispersion may further contain an additional toner component, as needed.

A method for forming aggregated particles in the aggregation step is not particularly limited. A method that includes adding a pH adjusting agent, a flocculant, a stabilizer, and so forth to the foregoing mixture and appropriately applying mechanical power (e.g., stirring) under heat to the resulting mixture may be employed.

Examples of the pH adjusting agent include, but are not particularly limited to, bases, such as ammonia and sodium hydroxide; and acids, such as nitric acid and citric acid.

Examples of the flocculant include surfactants each having a polarity opposite to that of the surfactant used for the dispersion of the particles; inorganic metal salts, such as sodium chloride, magnesium carbonate, magnesium chloride, magnesium nitrate, magnesium sulfate, calcium chloride, and aluminum sulfate; and divalent or higher-valent metal complexes.

Examples of the stabilizer include surfactants; and aqueous media containing surfactants.

Examples of the surfactant include, but are not particularly limited to, water-soluble polymers, such as polyvinyl alcohol, methyl cellulose, carboxymethyl cellulose, and sodium polyacrylate; anionic surfactants, such as sodium dodecylbenzenesulfonate, sodium octadecyl sulfate, sodium oleate, sodium laurate, and potassium stearate; cationic surfactants, such as laurylamine acetate, and lauryltrimethylammonium chloride; ampholytic surfactants, such as lauryldimethylamine oxide; nonionic surfactants, such as polyoxyethylene alkyl ether, polyoxyethylene alkylphenyl ether, and polyoxyethylene alkylamine; and inorganic compounds, such as tricalcium phosphate, aluminum hydroxide, calcium sulfate, calcium carbonate, and barium carbonate. These compounds may be used separately or in combination of two or more, as needed.

The average particle size of the aggregated particles formed here may be usually comparable to that of a toner to be produced. To prevent the coalescence of the aggregated particles, the pH adjusting agent, the surfactant, and so forth may be appropriately added.

In the coalescence step, heating the aggregated particles allows the particles to coalesce, thereby forming toner particles. The heating temperature may be a temperature between the glass transition temperature (Tg) of the resin contained in the aggregated particles and the decomposition temperature of the resin. For example, under stirring similar to that in the aggregation step, the progression of aggregation is stopped by the addition of a surfactant or the adjustment of the pH. The aggregated particles are heated to a temperature equal to or higher than the glass transition temperature of the resin in the resin particles, thereby allowing the aggregated particles to coalesce. The heating time may be such that the particles coalesce sufficiently. Specifically, the heating time may be in the range of about 10 minutes to about 10 hours.

Furthermore, a fine particle dispersion containing fine particles dispersed therein may be added to the foregoing mixture before or after the coalescence step, thereby attaching the fine particles to the surfaces of the aggregated particles to form toner particles each having a core-shell structure.

A toner particle-containing suspension obtained after the coalescence step is filtered, washed, dried, and so forth under appropriate conditions, thereby providing a toner. In this case, the toner particles may be sufficiently washed so as to have charging characteristics sufficient for a toner.

The washing step and the drying step are the same as those in the case of the production of the toner by the suspension polymerization.

Next, the production of a toner by the suspension granulation method will be described.

A production process by the suspension granulation method does not include a high-temperature heating step. The process results in the inhibition of compatibilization between a resin and a wax component, occurring when low-melting-point wax is used. This prevents a reduction in the glass transition temperature of the toner due to the compatibilization. Furthermore, the suspension granulation method offers a wide choice of options for a toner material to be formed into the binder resin. It is thus easy to use a polyester resin, which has advantageous fixability, as a main component. Hence, the suspension granulation method is advantageously used to produce a toner having a resin composition that is not produced by the suspension polymerization method.

A colorant containing the water-insoluble dye compound represented by formula (1), a binder resin, and, optionally, a wax component and so forth are mixed in a solvent to prepare a solvent-containing composition. The solvent-containing composition is dispersed in an aqueous medium to granulate particles of the solvent-containing composition, thereby providing a suspension of the solvent-containing composition. The removal of the solvent from the suspension of the solvent-containing composition under reduced pressure provides a suspension containing toner particles. The toner particles are separated from the resulting suspension containing the base toner particles. The separated toner particles are washed and dried.

The solvent-containing composition may be prepared by mixing a dispersion that contains the colorant dispersed in a first solvent with a second solvent. That is, the colorant containing the water-insoluble dye compound represented by formula (1) is sufficiently dispersed in the first solvent and then is mixed with the second solvent together with other toner materials, so that each of the toner components contained in the toner is present in the toner particles in a satisfactory dispersion state.

Examples of the solvent that may be used for the solvent-containing composition include aromatic hydrocarbons, such as toluene and xylene; aliphatic hydrocarbons, such as hexane, heptane, and octane; halogen-containing hydrocarbons, such as methylene chloride, chloroform, dichloroethane, a-trichloroethane, and carbon tetrachloride; alcohols, such as methanol, ethanol, butanol, and isopropanol; polyhydric alcohols, such as ethylene glycol, propylene glycol, diethylene glycol, and triethylene glycol; cellosolve, such as methyl cellosolve and ethyl cellosolve; ketones, such as acetone, methyl ethyl ketone, and methyl isobutyl ketone; ethers, such as benzyl alcohol ethyl ether, benzyl alcohol isopropyl ether, and tetrahydrofuran; and esters, such as methyl acetate, ethyl acetate, and butyl acetate. These solvents may be used separately or in combination of two or more, as needed. Among these solvents, a solvent which has a low boiling point and which is capable of sufficiently dissolving the binder resin may be used in order to readily remove the solvent in the toner particle suspension.

The amount of the solvent used for the solvent-containing composition is preferably in the range of 50 to 5000 parts by mass and more preferably 120 to 1000 parts by mass with respect to 100 parts by mass of the binder resin in view of the solubility of the binder resin and ease of the removal of the solvent.

The aqueous medium used in the suspension polymerization method may be used as the aqueous medium used in the suspension granulation method.

The aqueous medium may contain a water-miscible solvent. Examples of the solvent that may be contained include methanol, ethanol, isopropanol, ethylene glycol, dimethylformamide, tetrahydrofuran, methyl cellosolve, acetone, and methyl ethyl ketone. These solvents may be used separately or in combination of two or more, as needed.

In the suspension granulation method, a method for dispersing the solvent-containing composition in the aqueous medium and granulating the particles of the solvent-containing composition to provide the suspension of the solvent-containing composition is not particularly limited. For example, a known method using a rotary-shear homogenizer, a high-pressure counter collision-type disperser, an ultrasonic disperser, or the like may be employed.

Examples of a method for removing the solvent from the suspension of the solvent-containing composition to provide the toner particle-containing suspension include a method for evaporating and removing the solvent in the suspension by gradually increasing the temperature of the entire system to evaporate the solvent, by allowing a dry gas to flow in the system, or by reducing the pressure in the entire system. Alternatively, the suspension is sprayed into a dry atmosphere to evaporate and remove the aqueous medium together with the solvent in the solvent-containing composition.

The resulting toner particle-containing suspension is filtered, washed, dried, and so forth under appropriate conditions, thereby providing a toner. In this case, the toner particles may be sufficiently washed so as to have charging characteristics sufficient for a toner.

The washing step and the drying step are the same as those in the case of the production of the toner by the suspension polymerization.

Next, the production of a toner by the grinding method will be described.

In the case where a toner is produced by the grinding method, the toner may be produced with known production apparatuses, for example, a mixer, a heat kneading machine, and a classifier, which are known by those skilled in the art.

The materials are sufficiently mixed together using a mixer, for example, a Henschel mixer or a ball mill. The mixture is melted with a heat kneading machine, for example, a roll, a kneader, or an extruder and is then kneaded to compatibilize the resins. Wax and a magnetic material are dispersed therein. After cooling and hardening, grinding and classification are performed to provide a toner.

Examples of a binder resin used for the toner produced by the grinding method include vinyl resins, polyester resins, epoxy resins, polyurethane resins, polyvinyl butyral resins, terpene resins, phenol resins, aliphatic and alicyclic hydrocarbon resins, aromatic petroleum resins, rosins, modified rosins. Among these resins, vinyl resins and polyester resins may be used in view of the chargeability and fixability. In particular, the use of a polyester resin is effective in improving the chargeability and fixability.

These resins may be used separately or in combination of two or more.

In the case where two or more resins are used as a mixture, resins having different molecular weights may be mixed in order to control the viscoelastic properties of the toner.

Each of the binder resins preferably has a glass transition temperature of 45° C. to 80° C. and more preferably 55° C. to 70° C., a number-average molecular weight (Mn) of 2,500 to 50,000, and a weight-average molecular weight (Mw) of 10,000 to 1,000,000.

The ratio by mol % of the alcohol component to the acid component, i.e., alcohol component/acid component, of the polyester resin with respect to all components may be, but is not particularly limited to, 45/55 to 55/45.

An increase in the number of terminal groups of the molecular chains of the polyester resin leads to a higher degree of the dependence of the charging characteristics of the toner on the environment. Thus, the acid value is preferably 90 mg KOH/g or less and more preferably 50 mg KOH/g or less. Furthermore, the hydroxyl value is preferably 50 mg KOH/g or less and more preferably 30 mg KOH/g or less.

The polyester resin used in aspects of the present invention preferably has a glass transition temperature of 50° C. to 75° C. and more preferably 55° C. to 65° C.

The polyester resin used in aspects of the present invention preferably has a number-average molecular weight (Mn) of 1,500 to 50,000 and more preferably 2,000 to 20,000.

The polyester resin used in aspects of the present invention preferably has a weight-average molecular weight (Mw) of 6,000 to 100,000 and more preferably 10,000 to 90,000.

The magenta toner according to aspects of the present invention preferably has a weight-average particle diameter D4 of 4.0 to 9.0 μm and a ratio of the weight-average particle diameter D4 to the number-average particle diameter D1 (hereinafter, also referred to as “D4/D1”) of 1.35 or less in view of the charging stability and image reproducibility. More preferably, the magenta toner has a weight-average particle diameter D4 of 4.9 to 7.5 μm and a ratio of the weight-average particle diameter D4 to the number-average particle diameter D1, i.e., D4/D1, of 1.30 or less.

Each of the weight-average particle diameter D4 and the number-average particle diameter D1 of the magenta toner according to aspects of the present invention varies depending on a method for producing the base toner particles. For example, in the case of the suspension polymerization method, these average particle sizes may be adjusted by controlling the concentration of the dispersion stabilizer used in preparing the aqueous medium, the stirring speed during the reaction, stirring time during the reaction, and so forth. In the case of the emulsion aggregation method, the average particle size of the aggregated particles may be adjusted by controlling the timings and temperatures at the addition and mixing of the flocculant and so forth, the stirring and mixing conditions, and the like. In the case of the suspension granulation method, these average particle sizes may be adjusted by controlling the concentration of the solvent in preparing the solvent-containing composition, the concentration of the dispersion stabilizer used in preparing the aqueous medium, the stirring speed conditions, and the like.

The average circularity of the magenta toner according to aspects of the present invention is measured with a flow-type particle image analyzer. The magenta toner preferably has an average circularity of 0.950 to 0.995 and more preferably 0.960 to 0.990 from the viewpoint of achieving marked improvement in the transferability of the toner.

Next, a method for producing a liquid developer containing the water-insoluble dye compound represented by formula (1) according to aspects of the present invention will be described.

The magenta toner according to aspects of the present invention may be used as a liquid developer. The liquid developer will be described below.

The liquid developer may be produced by dispersing or dissolving toner particles in an insulating carrier liquid, the toner particles containing a dispersant resin used as a dispersant and a colorant that contains the water-insoluble dye compound represented by formula (1). The toner particles may optionally contain auxiliary agents, such as a charge control agent and wax. Alternatively, the liquid developer may be prepared by a two-stage method that includes making a concentrated toner in advance and diluting the concentrated toner with the insulating carrier liquid.

Examples of the dispersant resin for use in the liquid developer include, but are not particularly limited to, homopolymers of styrene monomers, such as styrene, p-chlorostyrene, and α-methylstyrene, acrylate monomers, such as methyl acrylate, ethyl acrylate, n-propyl acrylate, lauryl acrylate, 2-ethylhexyl acrylate, and acrylonitrile, methacrylate monomers, such as methyl methacrylate, ethyl methacrylate, n-propyl methacrylate, lauryl methacrylate, 2-ethylhexyl methacrylate, and methacrylonitrile, vinyl ether monomers, such as vinyl methyl ether and vinyl isobutyl ether, vinyl ketone monomers, such as vinyl methyl ketone, vinyl ethyl ketone, and vinyl isopropenyl ketone, and olefin monomers, such as ethylene, propylene, and butadiene; copolymers prepared by combinations of two or more thereof; and mixtures of the homopolymers and the copolymers. Further examples thereof include epoxy resins, polyester resins, polyurethane resins, polyamide resins, cellulose resins, polyether resins and non-vinyl condensed resins; mixtures of these resins and the vinyl resins described above; and graft polymers prepared by the polymerization of vinyl monomers in the presence thereof. These resins may be used separately or in combination of two or more, as needed.

The insulating carrier liquid that may be used in the liquid developer is not particularly limited. For example, an organic solvent having a high electric resistivity of 10⁹ Ω·cm or more and a low dielectric constant of 3.0 or less may be used in view of the transferability of the liquid developer. Specific examples of the organic solvent include aliphatic hydrocarbons, such as pentane, hexane, heptane, octane, nonane, decane, undecane, and dodecane; Isoper H, G, K, L, and M (manufactured by Exxon Chemical Co., Ltd.); and Linealene Dimer A-20 and A-20H (manufactured by Idemitsu Kosan Co., Ltd). The organic solvent may have a boiling point of 68° C. to 250° C. These solvents may be used separately or in combination of two or more, as needed, to the extent that the viscosity of the system is not increased.

Examples of the charge control agent that may be used for the liquid developer include, but are not particularly limited to, charge control agents used in a liquid developer for electrostatic charge development. Examples thereof include cobalt naphthenate, copper naphthenate, copper oleate, cobalt oleate, zirconium octanoate, cobalt octanoate, sodium dodecylbenzenesulfonate, calcium dodecylbenzenesulfonate, soybean lecithin, and aluminum octoate.

Examples of the disperser that may be used for the liquid developer include, but are not particularly limited to, rotary-shear homogenizers, media-type dispersers, e.g., ball mills, sand mills, and attritors, and high-pressure counter collision-type dispersers.

### EXAMPLES

While aspects of the present invention will be described in further detail below by examples and comparative examples, the present invention is not limited to these examples. In the following description, “part(s)” and “%” are on a mass basis unless otherwise specified. The resulting reaction products are identified by a plurality of analytical methods with apparatuses described below. That is, analytical apparatuses used were a ¹H-nuclear magnetic resonance spectrometer (ECA-400, manufactured by JEOL Ltd.), a LC/TOF mass spectroscope (LC/MSD TOF, manufactured by Agilent Technologies), and a UV/Vis spectrophotometer (UV-3600 Spectrophotometer, manufactured by Shimadzu Corporation). With respect to an ionization method in the LC/TOF MS, an electro-spray ionization (ESI) method was employed.

Water-insoluble dye compounds represented by formula (1) were produced by the following methods.

### Synthesis Example 1

### Production of Water-Insoluble Dye Compound (5)

First, 3-acetylamino-2,4,6-trimethylaniline (7.3 g) and compound A (7.4 g) illustrated in the foregoing synthetic scheme were reacted in sulfolane (20 mL) under heat at 150° C. for 3 hours in the presence of zinc chloride (4.1 g). The resulting solution was cooled and then poured into 2 N hydrochloric acid (50 mL). The precipitated crystals were filtered, washed with water, and crystallized from acetone to give water-insoluble dye compound (5).

The resulting compound was identified by ¹H-NMR spectroscopy, LC/TOF MS, and UV/Vis spectrophotometry using the foregoing analytical apparatuses. The analytical results were described below.

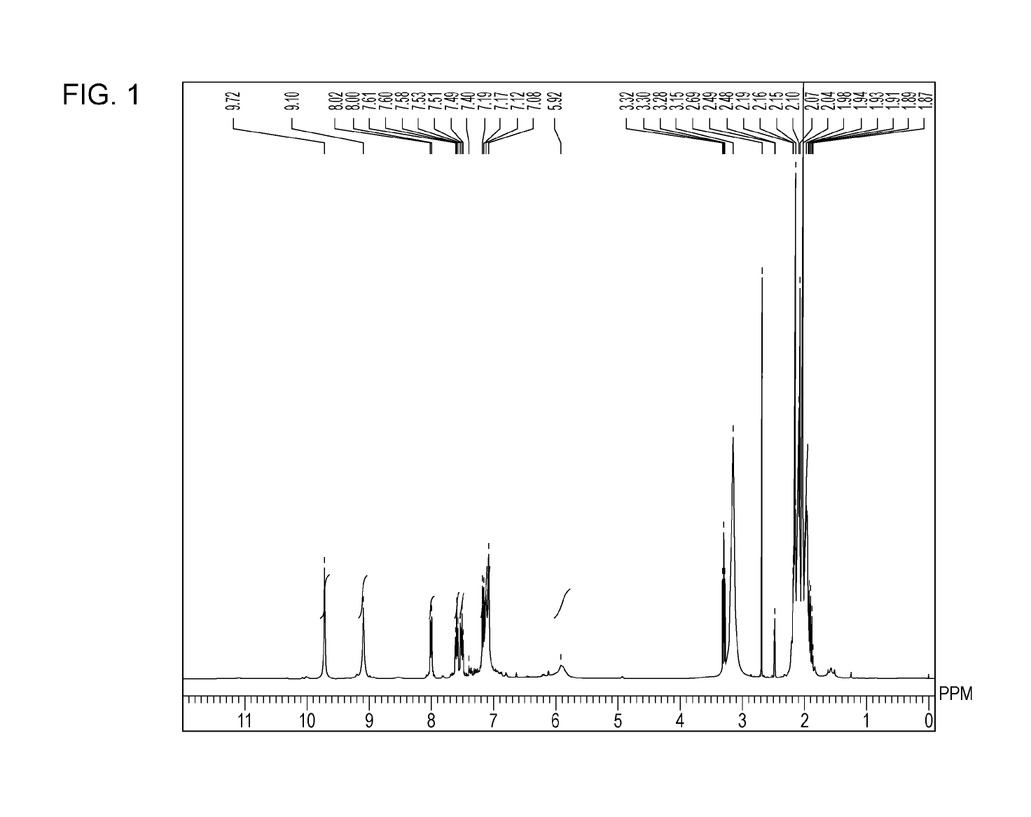

### Analytical Result of Water-Insoluble Dye Compound (5)

[1] ¹H-NMR (400 MHz, DMSO-d₆, 80° C.) (see FIG. 1): δ [ppm]=9.72 (s, 2H), 9.10 (s, 2H), 8.01 (d, 1H, J=7.63 Hz), 7.60 (t, 1H, J=7.25 Hz), 7.51 (t, 1H, J=7.63 Hz), 7.18-7.08 (m, 7H), 5.92 (br, 1H), 2.16-1.98 (m, 24H)

[2] Mass spectrometry (ESI-TOF): m/z=715.2696 (M−H)⁻

[3] UV/Vis spectrophotometry: λₘₐₓ=530 nm (CH₃OH: 2.5×10⁻⁵ mol/L)

Note that water-insoluble dye compound (5) described above and water-insoluble dye compounds (1) to (4) and (6) to (25) described below each had a solubility in water of less than 1% by mass and thus were water-insoluble compounds.

### Synthesis Example 2

### Production of Water-Insoluble Dye Compound (6)

Water-insoluble dye compound (6) was prepared as in Synthesis Example 1, except that 3-propionylamino-2,4,6-trimethylaniline was used in place of 3-acetylamino-2,4,6-trimethylaniline and in an amount of 1.3 times the molar amount of 3-acetylamino-2,4,6-trimethylaniline.

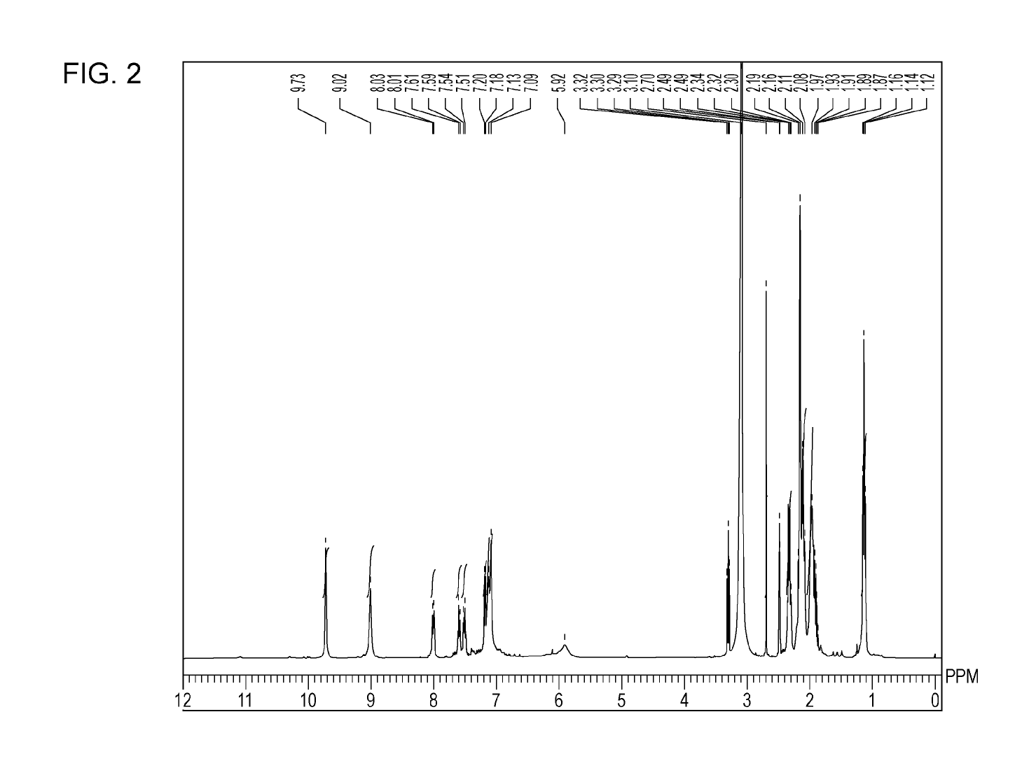

### Analytical Result of Water-Insoluble Dye Compound (6)

[1] ¹H-NMR (400 MHz, DMSO-d₆, 80° C.) (see FIG. 2): δ [ppm]=9.73 (s, 2H), 9.02 (s, 2H), 8.02 (d, 1H, J=7.63 Hz), 7.60 (t, 1H, J=7.63 Hz), 7.53 (t, 1H, J=8.39 Hz), 7.19-7.09 (m, 7H), 5.92 (br, 1H), 2.32 (t, 4H, J=7.63 Hz), 2.16-1.97 (m, 16H), 1.14 (t, 6H, J=7.63 Hz)

[2] Mass spectrometry (ESI-TOF): m/z=743.2976 (M−H)⁻

[3] UV/Vis spectrophotometry: λₘₐₓ=530 nm (CH₃OH: 2.5×10⁻⁵ mol/L)

### Synthesis Example 3

### Production of Water-Insoluble Dye Compound (7)

Water-insoluble dye compound (7) was prepared as in Synthesis Example 1, except that 3-butyrylamino-2,4,6-trimethylaniline was used in place of 3-acetylamino-2,4,6-trimethylaniline and in an amount of 1.5 times the molar amount of 3-acetylamino-2,4,6-trimethylaniline.

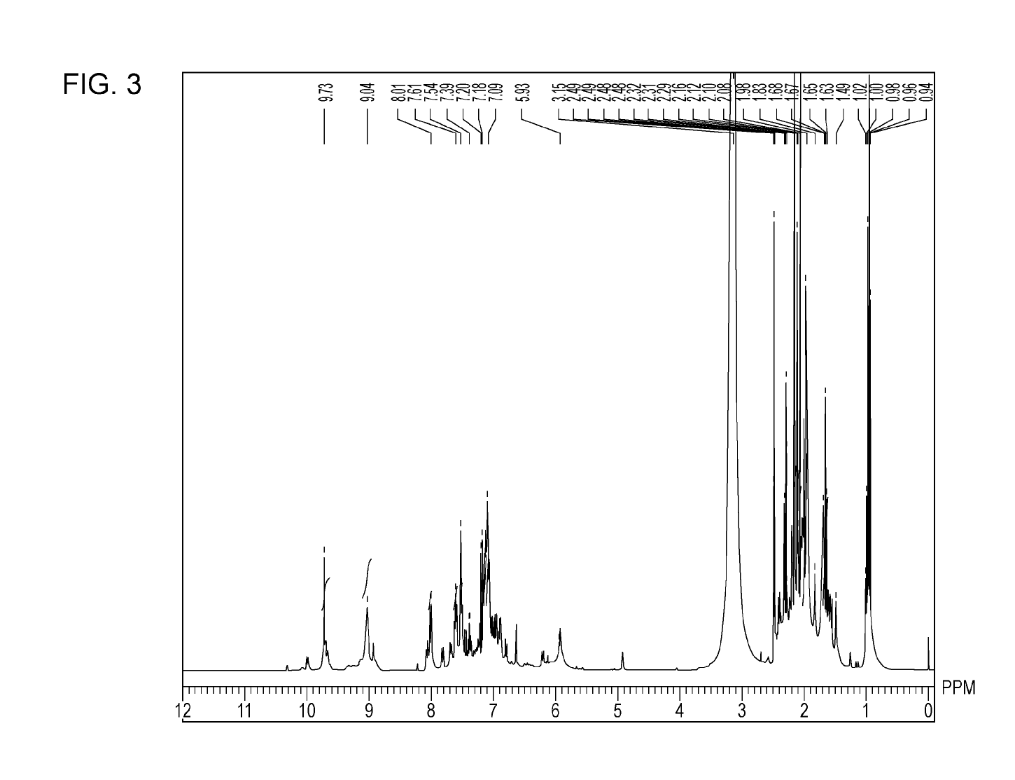

### Analytical Result of Water-Insoluble Dye Compound (7)

[1] ¹H-NMR (400 MHz, DMSO-d₆, 80° C.) (see FIG. 3): δ [ppm]=9.73 (s, 2H), 9.04 (s, 2H), 8.01 (d, 1H, J=7.63 Hz), 7.61 (t, 1H, J=7.63 Hz), 7.54 (t, 1H, J=8.39 Hz), 7.19-7.09 (m, 7H), 5.93 (br, 1H), 2.31 (t, 4H, J=7.25 Hz), 2.16-1.98 (m, 18H), 1.66 (dd, 6H, J=14.9, 7.25 Hz), 0.96 (t, 6H, J=7.25 Hz)

[2] Mass spectrometry (ESI-TOF): m/z=771.3306 (M−H)⁻

[3] UV/Vis spectrophotometry: λₘₐₓ=530 nm (CH₃OH: 2.5×10⁻⁵ mol/L)

### Synthesis Example 4

### Production of Water-Insoluble Dye Compound (8)

Water-insoluble dye compound (8) was prepared as in Synthesis Example 1, except that 3-isobutyrylamino-2,4,6-trimethylaniline was used in place of 3-acetylamino-2,4,6-trimethylaniline and in an amount equal to the molar amount of 3-acetylamino-2,4,6-trimethylaniline and that the amount of sulfolane used was doubled.

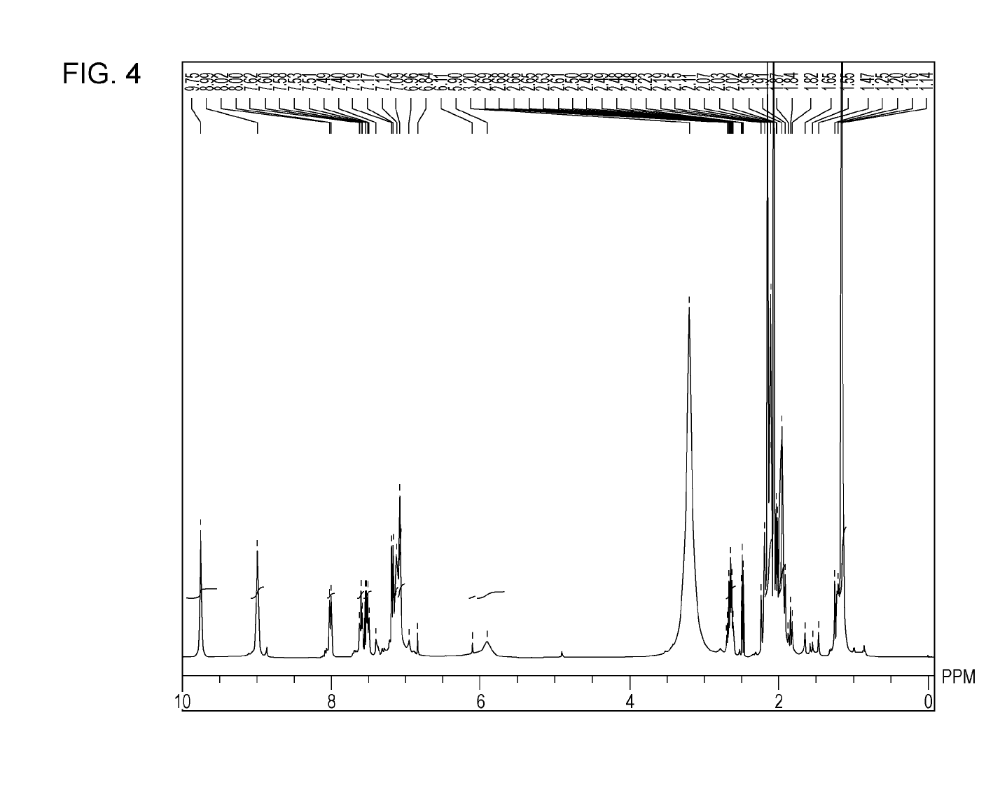

### Analytical Result of Water-Insoluble Dye Compound (8)

[1] ¹H-NMR (400 MHz, DMSO-d₆, 80° C.) (see FIG. 4): δ [ppm]=9.75 (s, 2H), 8.99 (s, 2H), 8.01 (d, 1H, J=8.39 Hz), 7.60 (t, 1H, J=7.63 Hz), 7.51 (t, 1H, J=8.01 Hz), 7.18-7.09 (m, 7H), 5.90 (br, 1H), 2.65 (td, 2H, J=13.4, 6.36 Hz), 2.13 (m, 11H), 1.96 (m, 6H), 1.15 (m, 13H)

[2] Mass spectrometry (ESI-TOF): m/z=771.3295 (M−H)⁻

[3] UV/Vis spectrophotometry: λₘₐₓ=530 nm (CH₃OH: 2.5×10⁻⁵ mol/L)

### Synthesis Example 5

### Production of Water-Insoluble Dye Compound (10)

Water-insoluble dye compound (10) was prepared as in Synthesis Example 1, except that 3-benzoylamino-2,4,6-trimethylaniline was used in place of 3-acetylamino-2,4,6-trimethylaniline and in an amount of 1.8 times the molar amount of 3-acetylamino-2,4,6-trimethylaniline.

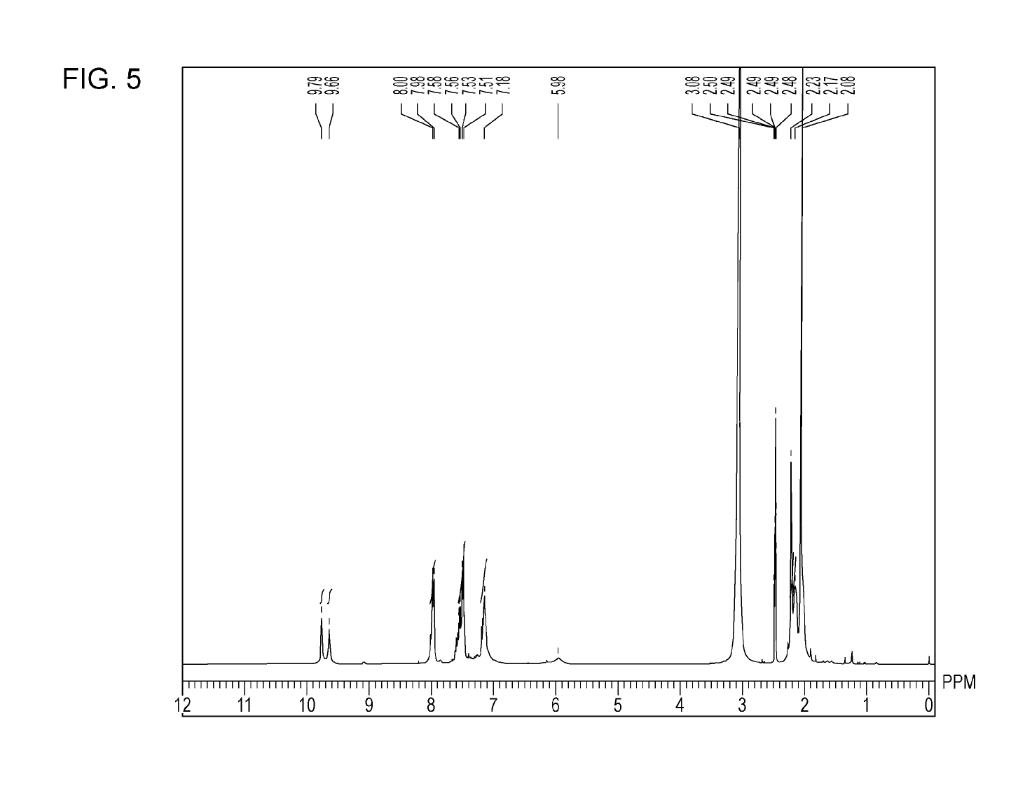

### Analytical Result of Water-Insoluble Dye Compound (10)

[1] ¹H-NMR (400 MHz, DMSO-d₆, 80° C.) (see FIG. 5): δ [ppm]=9.79 (s, 2H), 9.66 (s, 2H), 7.99 (d, 6H, J=7.63 Hz), 7.58-7.51 (m, 8H), 7.18 (m, 6H), 7.18-7.09 (m, 7H), 5.98 (br, 1H), 2.23-2.08 (m, 18H)

[2] Mass spectrometry (ESI-TOF): m/z=839.2973 (M−H)⁻

[3] UV/Vis spectrophotometry: λₘₐₓ=530 nm (CH₃OH: 2.5×10⁻⁵ mol/L)

### Synthesis Example 6

### Production of Water-Insoluble Dye Compound (24)

Water-insoluble dye compound (24) was prepared as in Synthesis Example 1, except that 3-(2-heptylundecanoylamino)-2,4,6-trimethylaniline was used in place of 3-acetylamino-2,4,6-trimethylaniline and in an amount of 2 times the molar amount of 3-acetylamino-2,4,6-trimethylaniline.

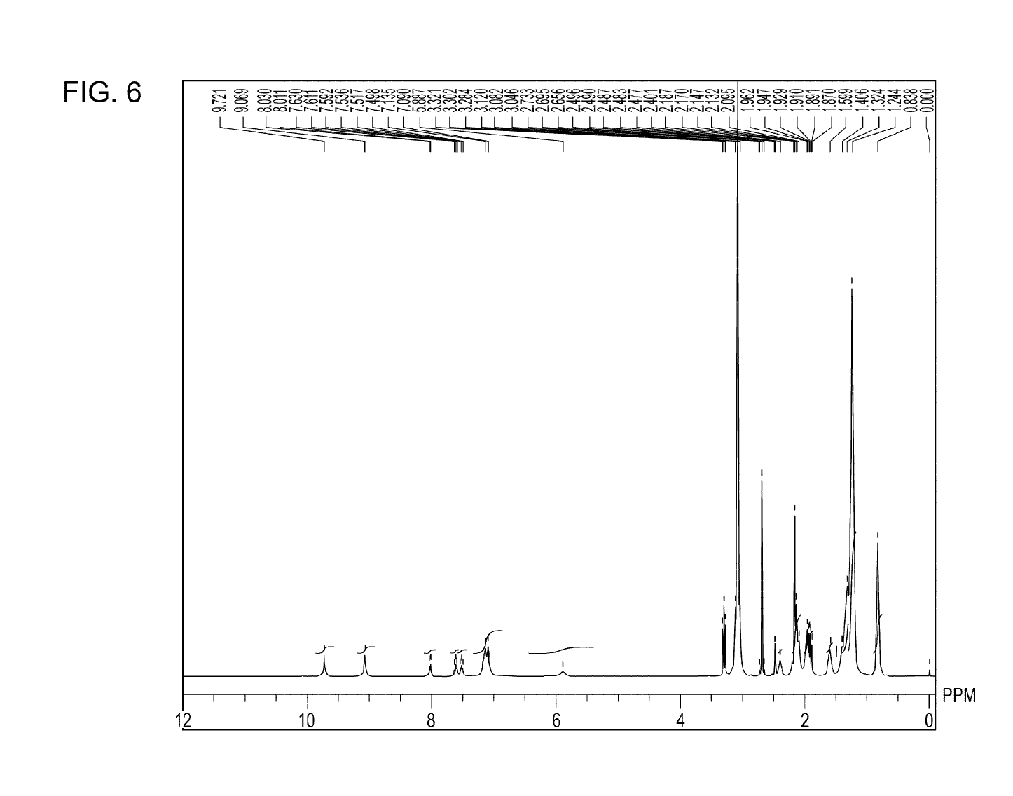

### Analytical Result of Water-Insoluble Dye Compound (24)

[1] ¹H-NMR (400 MHz, DMSO-d₆, 80° C.) (see FIG. 6): δ [ppm]=9.72 (s, 2H), 9.07 (s, 2H), 8.02 (d, 1H, J=7.63 Hz), 7.61 (t, 1H, J=7.63 Hz), 7.52 (t, 1H, J=7.63 Hz), 7.11 (m, 7H), 5.89 (br, 2H), 3.30 (t, 2H, J=7.25 Hz), 2.69 (s, 3H), 2.40 (s, 1H), 2.19-2.10 (m, 12H), 1.92 (m, 7H), 1.60 (s, 3H), 1.41 (s, 1H), 1.32 (s, 9H), 1.24 (s, 38H), 0.84 (s, 12H)

Mass spectrometry (ESI-TOF): m/z=1165.7665 (M+H)⁺

[3] UV/Vis spectrophotometry: λₘₐₓ=531 nm (CH₃OH: 2.5×10⁻⁵ mol/L)

### Synthesis Example 7

### Production of Water-Insoluble Dye Compound (25)

Water-insoluble dye compound (25) was prepared as in Synthesis Example 1, except that 3-(2-(1,3,3-trimethylbutyl)-5,7,7-trimethyl)octanoylamino-2,4,6-trimethylaniline was used in place of 3-acetylamino-2,4,6-trimethylaniline and in an amount of 2 times the molar amount of 3-acetylamino-2,4,6-trimethylaniline.

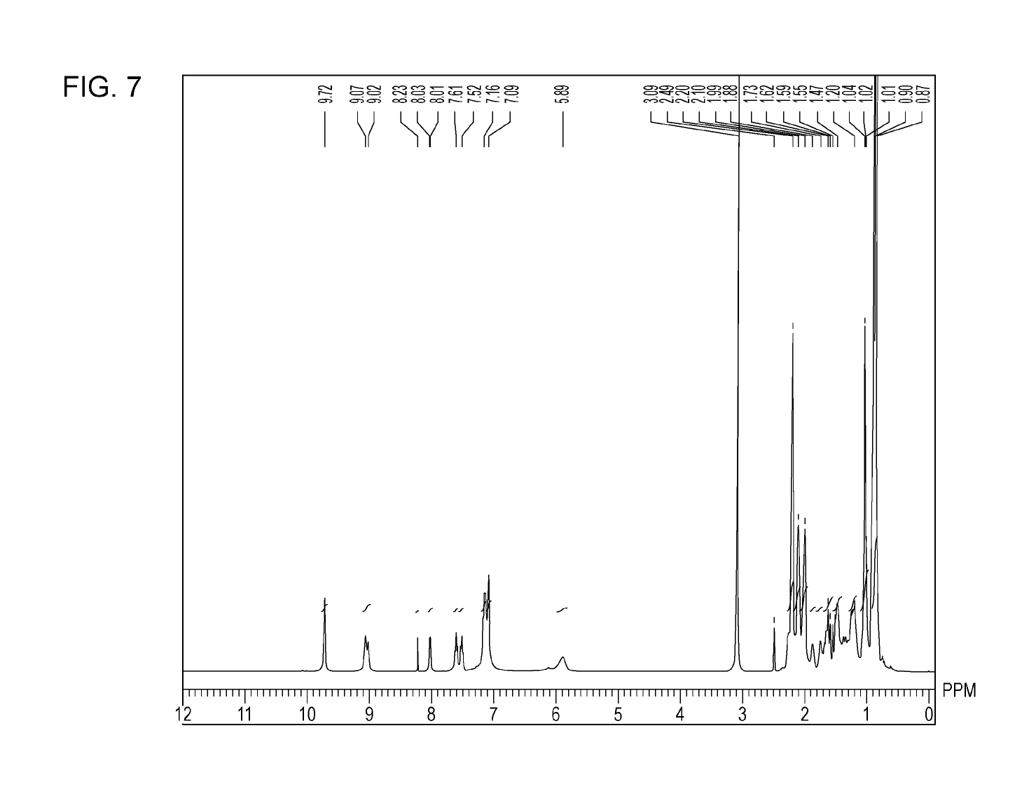

### Analytical Result of Water-Insoluble Dye Compound (25)

[1] ¹H-NMR (400 MHz, DMSO-d₆, 80° C.) (see FIG. 7): δ [ppm]=9.72 (s, 2H), 9.04 (s, 2H), 8.02 (d, 1H, J=7.63 Hz), 7.61 (t, 1H, J=7.63 Hz), 7.52 (t, 1H, J=8.01 Hz), 7.16-7.09 (m, 7H), 5.89 (br, 1H), 2.20-1.99 (m, 18H), 1.99-1.58 (m, 8H), 1.47-1.20 (m, 12H), 1.02-0.87 (m, 48H)

Mass spectrometry (ESI-TOF): m/z=1165.7878 (M+H)⁺

[3] UV/Vis spectrophotometry: λₘₐₓ=531 nm (CH₃OH: 2.5×10⁻⁵ mol/L)

### Synthesis Examples of Other Water-Insoluble Dye Compounds

Water-insoluble dye compounds (9) and (11) to (23) illustrated in Table 1 were synthesized by methods according to Synthesis Examples 1 to 7. The resulting water-insoluble dye compounds were identified by ¹H-NMR spectroscopy, LC/TOF MS, and UV/Vis spectrophotometry using the foregoing analytical apparatuses.

Note that water-insoluble dye compound (5) to (25) each had a solubility in water of less than 1% by mass.

In Table 1, “nC₁₇H₁₅” represents a n-stearyl group, and “*” represents a bonding site.

TABLE 1
Structure of dye compound represented by formula (1)

| Compound | R₁ | R₂ | R₃ | R₄ | R₅ | R₆ | R₇ | R₈ | R₉ | R₁₀ |
|---|---|---|---|---|---|---|---|---|---|---|
| (5) | CH₃ | CH₃CONH | CH₃ | H | CH₃ | CH₃ | CH₃CONH | CH₃ | H | CH₃ |
| (6) | CH₃ | CH₃CH₂CONH | CH₃ | H | CH₃ | CH₃ | CH₃CH₂CONH | CH₃ | H | CH₃ |
| (7) | CH₃ | CH₃CH₂CH₂CONH | CH₃ | H | CH₃ | CH₃ | CH₃CH₂CH₂CONH | CH₃ | H | CH₃ |
| (8) | CH₃ | (CH₃)₂CHCONH | CH₃ | H | CH₃ | CH₃ | (CH₃)₂CHCONH | CH₃ | H | CH₃ |
| (9) | CH₃ | 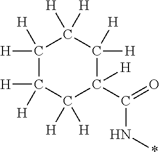 [SMILES: *NC(=O)C1CCCCC1] | CH₃ | H | CH₃ | CH₃ | 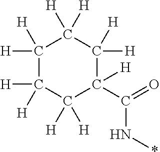 [SMILES: *NC(=O)C1CCCCC1] | CH₃ | H | CH₃ |
| (10) | CH₃ | 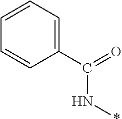 [SMILES: *NC(=O)c1ccccc1] | CH₃ | H | CH₃ | CH₃ | 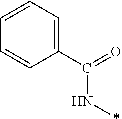 [SMILES: *NC(=O)c1ccccc1] | CH₃ | H | CH₃ |
| (11) | CH₃ | CH₃CONH | CH₃ | CH₃CONH | CH₃ | CH₃ | CH₃CONH | CH₃ | CH₃CONH | CH₃ |
| (12) | CH₃ | 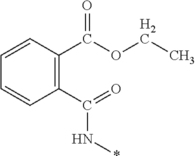 [SMILES: *NC(=O)c1ccccc1C(=O)OCC] | CH₃ | H | CH₃ | CH₃ | 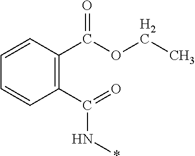 [SMILES: *NC(=O)c1ccccc1C(=O)OCC] | CH₃ | H | CH₃ |
| (13) | CH₃ | CH₃CONH | CH₃ | CH₃CONH | CH₃ | CH₃ | CH₃CONH | CH₃ | H | CH₃ |
| (14) | CH₃CH₂ | CH₃CONH | H | H | CH₃CH₂ | CH₃CH₂ | CH₃CONH | H | H | CH₃CH₂ |
| (15) | CH₃CH₂ | CH₃CONH | H | H | CH₃CH₂ | CH₃ | CH₃CONH | H | H | CH₃ |
| (16) | (CH₃)₂CH | CH₃CONH | H | H | (CH₃)₂CH | CH₃ | CH₃CONH | H | H | CH₃ |
| (17) | CH₃ | CH₃CONH | CH₃ | CH₃CONH | CH₃ | CH₃ | CH₃CONH | H | CH₃CONH | CH₃ |
| (18) | CH₃ | CH₃CONH | CH₃CH₂O | H | CH₃ | CH₃ | CH₃CONH | CH₃CH₂O | H | CH₃ |
| (19) | CH₃ | CH₃CONH | 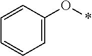 [SMILES: *Oc1ccccc1] | H | CH₃ | CH₃ | CH₃CONH | 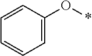 [SMILES: *Oc1ccccc1] | H | CH₃ |
| (20) | CH₃ | 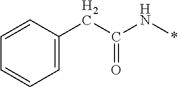 [SMILES: *NC(=O)Cc1ccccc1] | CH₃ | H | CH₃ | CH₃ | 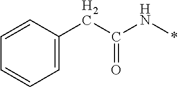 [SMILES: *NC(=O)Cc1ccccc1] | CH₃ | H | CH₃ |
| (21) | CH₃ | 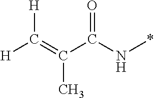 [SMILES: *NC(=O)C(=C)C] | CH₃ | H | CH₃ | CH₃ | 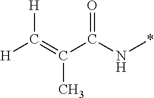 [SMILES: *NC(=O)C(=C)C] | CH₃ | H | CH₃ |
| (22) | CH₃ | 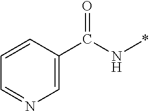 [SMILES: *NC(=O)c1cccnc1] | CH₃ | H | CH₃ | CH₃ | 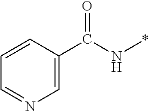 [SMILES: *NC(=O)c1cccnc1] | CH₃ | H | CH₃ |
| (23) | CH₃ | 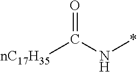 | CH₃ | H | CH₃ | CH₃ | 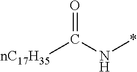 | CH₃ | H | CH₃ |
| (24) | CH₃ | 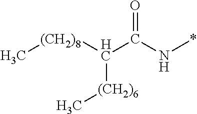 | CH₃ | H | CH₃ | CH₃ | 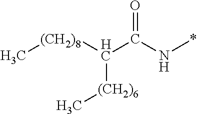 | CH₃ | H | CH₃ |
| (25) | CH₃ | 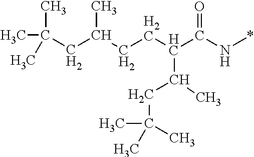 [SMILES: *NC(=O)C(CCC(C)CC(C)(C)C)C(C)CC(C)(C)C] | CH₃ | H | CH₃ | CH₃ | 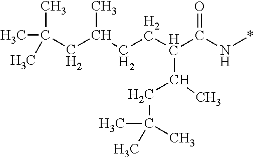 [SMILES: *NC(=O)C(CCC(C)CC(C)(C)C)C(C)CC(C)(C)C] | CH₃ | H | CH₃ |

### Production of Toner

A magenta toner was produced by a method described below.

### Production Example of Resin Particle Dispersion (1)

First, 82.6 parts of styrene, 9.2 parts of n-butyl acrylate, 1.3 parts of acrylic acid, 0.4 parts of hexanediol acrylate, and 3.2 parts of n-lauryl mercaptan were mixed and dissolved. An aqueous solution of 1.5 parts of NEOGEN RK (manufactured by Dai-ichi Kogyo Seiyaku Co., Ltd.) in 150 parts of ion-exchanged water was added to the resulting solution and dispersed therein. An aqueous solution of 0.15 parts of potassium persulfate in 10 parts of ion-exchanged water was added to the dispersion with slow stirring for another 10 minutes. The atmosphere in the system was replaced with nitrogen, emulsion polymerization was then performed at 70° C. for 6 hours. After the completion of the polymerization, the reaction mixture was cooled to room temperature. The addition of ion-exchanged water to the reaction mixture gave resin particle dispersion (1) having a solid content of 12.5% by mass and a median size (D50) of 0.2 μm on a volume basis.

### Production Example of Colorant Particle Dispersion (1)

First, 100 parts of water-insoluble dye compound (5) and 15 parts of NEOGEN RK (manufactured by Dai-ichi Kogyo Seiyaku Co., Ltd.) were added to 885 parts of ion-exchanged water. The mixture was dispersed for about 1 hour with a wet jet mill (Model: JN100, manufactured by JOKOH Co., Ltd.) to provide colorant particle dispersion (1). The colorant particles in the colorant particle dispersion had a median size (D50) of 0.2 μm on a volume basis. The colorant particle dispersion had a colorant particle content of 10% by mass.

### Production Example of Wax Particle Dispersion (1)

First, 100 parts of an ester wax (the peak temperature of the maximum endothermic peak measured by DSC: 70° C., Mn=704) and 15 parts of NEOGEN RK (manufactured by Dai-ichi Kogyo Seiyaku Co., Ltd.) were added to 385 parts of ion-exchanged water. The mixture was dispersed for about 1 hour with a wet jet mill (Model: JN100, manufactured by JOKOH Co., Ltd.) to provide a wax particle dispersion (1). The resulting wax particle dispersion had a wax content of 20% by mass.

### Production Example of Base Toner Particles (1)

First, 160 parts of resin particle dispersion (1), 10 parts of colorant particle dispersion (1), 10 parts of wax particle dispersion (1), and 0.2 parts of magnesium sulfate were mixed together and dispersed with a homogenizer (Model: ULTRA-TURRAX T 50, manufactured by IKA). The mixture was heated to 65° C. under stirring. Stirring was continued at 65° C. for 1 hour. Observation was made with an optical microscope and demonstrated that aggregated particles having a number-average particle diameter of about 6.0 μm were formed. After the addition of 2.2 parts of NEOGEN RK (manufactured by Dai-ichi Kogyo Seiyaku Co., Ltd.), the resulting mixture was heated to 80° C. and stirred for 120 minutes to provide coalescent spherical base toner particles. The mixture was cooled and filtered to separate a solid. Then 720 parts of ion-exchanged water was added to the separated solid. The resulting mixture was stirred for 60 minutes. The mixture containing the base toner particles was filtered. The same washing and filtration were repeated until the electrical conductivity of the filtrate reached 150 μS/cm or less. Finally, filtration was performed to separate a solid. Drying the solid with a vacuum dryer gave base toner particles (1).

Note that the electrical conductivity of the filtrate was calculated according to a method described in Japanese Patent Laid-Open No. 2006-243064. That is, 30 parts of the first portion of the filtrate was discarded. The temperature of the remainder was set to 25±0.5° C. The electrical conductivity was measured with an electrical conductivity meter (Model: ES-12, manufactured by HORIBA, Ltd.). The electrical conductivity of the sample was calculated from the following expression:

Electrical conductivity[μS/cm]=A−B

wherein A represents the electrical conductivity of the filtrate; and B represents the electrical conductivity of water used for the washing.

Note that ion-exchanged water having an electrical conductivity of 5 μS/cm or less and a pH of 7.0±1.0 was used.

### Production Example of Base Toner Particles (2)

Base toner particles (2) were produced as in the production example of base toner particles (1), except that water-insoluble dye compound (8) was used in place of water-insoluble dye compound (5) in a method according to the production example of colorant particle dispersion (1).

### Production Example of Colored Fine Resin Particle Dispersion (1)

In a nitrogen gas atmosphere, 4.0 mol of terephthalic acid, 1.0 mol of isophthalic acid, and 0.04 mol of dibutyltin oxide were added to a mixed solution of 1.5 mol of a 2-mol propylene oxide adduct of bisphenol A and 1.8 mol of a 2-mol trimethylene oxide adduct of bisphenol A in 1.1 mol of cyclohexanedimethanol and 0.62 mol of ethylene glycol. The mixture was reacted at 195° C. for 6 hours under stirring. Then the mixture was heated to 240° C. and reacted for 6 hours. The pressure in the reaction vessel was reduced to 10.0 mmHg. The mixture was reacted for 0.5 hours under reduced pressure to give clear pale yellow amorphous linear polyester resin (1). Amorphous linear polyester resin (1) had a glass transition temperature Tg measured by DSC of 56° C. Amorphous linear polyester resin (1) had a weight-average molecular weight Mw of 11,300, a number-average molecular weight Mn of 4,400, and a Mw/Mn ratio of 2.6, the molecular weights being measured by GPC in terms of styrene. Amorphous linear polyester resin (1) had an acid value of 12 mg KOH/g, the acid value being measured according to JIS K0070 using an acetone-toluene mixed solution.

Next, water-insoluble dye compound (8) and amorphous linear polyester resin (1) were dispersed with a high-temperature and high-pressure disperser made by modifying a disperser (Model: Cavitron CD1010, manufactured by EuroTec, Ltd). Specifically, 79 parts of ion-exchanged water, 1 part of NEOGEN RK (manufactured by Dai-ichi Kogyo Seiyaku Co., Ltd.), 1 part of water-insoluble dye compound (8), and 20 parts of amorphous linear polyester resin (1) were mixed together. Ammonia was added to the mixture to adjust the pH of the mixture to 8.5. The resulting mixture was treated by operating the modified Cavitron disperser at a rotation speed of an impeller of 60 Hz and a pressure of 5 kg/cm², the mixture being heated at 140° C. using a heat exchanger. Thereby, colored fine resin particle dispersion (1) having a number-average particle diameter of 290 nm was produced.

### Production Example of Base Toner Particles (3)

First, 160 parts of colored fine resin particle dispersion (1), 10 parts of wax particle dispersion (1), and 0.2 parts of magnesium sulfate were mixed together and dispersed with a homogenizer (Model: ULTRA-TURRAX T 50, manufactured by IKA). The mixture was heated to 65° C. under stirring. Stirring was continued at 65° C. for 1 hour. Observation was made with an optical microscope and demonstrated that aggregated particles having an average particle size of about 6.0 μm were formed. After the addition of 2.2 parts of NEOGEN RK (manufactured by Dai-ichi Kogyo Seiyaku Co., Ltd.), the resulting mixture was heated to 80° C. and stirred for 120 minutes to provide coalescent spherical base toner particles. The mixture was cooled and filtered to separate a solid. Then the separated solid was washed with 720 parts of ion-exchanged water for 60 minutes. The mixture containing the base toner particles was filtered. The same washing and filtration were repeated until the electrical conductivity of the filtrate reached 150 μS/cm or less. Drying the solid with a vacuum dryer gave base toner particles (3).

### Production Examples of Toners (1) to (3)

To 100 parts of each of base toner particles (1) to (3), 1.00 part of a hydrophobic fine silica powder (primary particles having a number-average particle diameter of 7 nm) surface-treated with hexamethyldisilazane, 0.15 parts of a fine rutile titanium oxide powder (primary particles having a number-average particle diameter of 45 nm), and 0.50 parts of a fine rutile titanium oxide powder (primary particles having a number-average particle diameter of 200 nm) were added. Each of the resulting mixtures was subjected to dry-mixing using a Henschel mixer (manufactured by Nippon Coke & Engineering Co., Ltd.) for 5 minutes to produce toners (1) to (3).

### Production Examples of Comparative Toners (1) to (3)

Comparative toners (1) to (3) were produced as in the production examples of toner (1), except that comparative compounds (1) to (3) illustrated below were used in place of water-insoluble dye compound (5) in a method according to the production example of colorant particle dispersion (1).

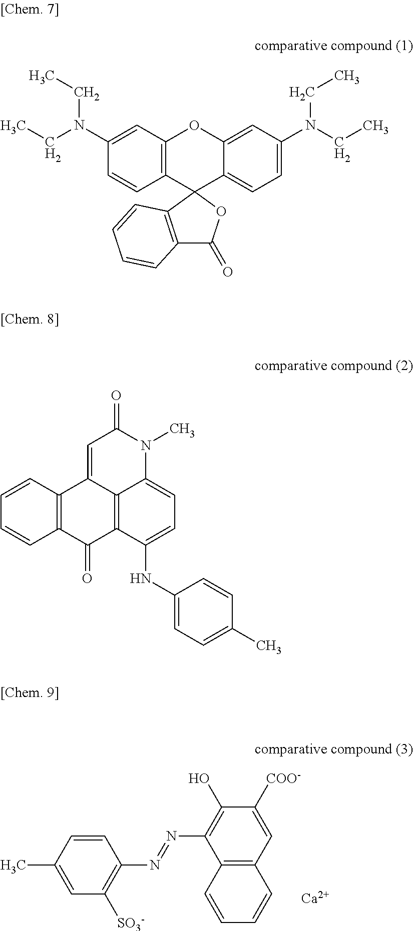

### Production Example of Toner (4)

To a 2-L four-necked flask equipped with a high-speed agitator (Model: T.K. HOMO MIXER, manufactured by PRIMIX Corporation), 710 parts of ion-exchanged water and 450 parts of an aqueous solution of 0.1 mol/L trisodium phosphate were added. The number of revolutions was set at 12,000 rpm. The mixture was heated to 60° C. Then 68 parts of an aqueous solution of 1.0 mol/L calcium chloride was gradually added to the mixture to prepare an aqueous dispersion medium containing calcium phosphate that served as a minute poorly water-soluble dispersion stabilizer.

A mixture of 12 parts of water-insoluble dye compound (8) and 120 parts of styrene was dispersed with an attritor (manufactured by Mitsui Mining Co., Ltd.) for 3 hours to provide masterbatch (1).

| | |
|---|---|
| Masterbatch (1) | 133.2 parts |
| Styrene monomer | 46.0 parts |
| n-Butyl acrylate monomer | 34.0 parts |
| Aluminum salicylate compound | 2.0 parts |
| (BONTRON E-88, manufactured by Orient Chemical | |
| Industries Co., Ltd.) | |
| Polar resin | 10.0 parts |
| (polycondensate of propylene oxide-modified bisphenol A | |
| and isophthalic acid, Tg = 65° C., Mw = 10,000, | |
| Mn = 6,000) | |
| Ester wax | 25.0 parts |
| (peak temperature of the maximum endothermic peak | |
| measured by DSC: 70° C., Mn = 704) | |
| Divinylbenzene monomer | 0.10 parts |

The foregoing formulation was heated to 60° C. and uniformly dissolved or dispersed with T.K. HOMO MIXER at 5,000 rpm. Then 10 parts of 2,2′-azobis(2,4-dimethylvaleronitrile) serving as a polymerization initiator was dissolved therein to prepare a polymerizable monomer composition. The polymerizable monomer composition was fed into the aqueous medium. The resulting mixture was granulated for 15 minutes while the number of revolutions was maintained at 12,000 rpm. Next, the high-speed agitator was changed to an agitator provided with propeller blades. The polymerization was continued for 5 hours at a mixture temperature of 60° C. The temperature of the mixture was increased to 80° C. The polymerization was continued for 8 hours. After the completion of the polymerization reaction, the remaining monomers were removed at 80° C. under reduced pressure. The temperature of the mixture was cooled to 30° C. to give a fine polymer particle dispersion.

The fine polymer particle dispersion was transferred to a washing vessel. Dilute hydrochloric acid was added thereto under stirring to adjust the pH to 1.5. Stirring was continued for 2 hours. Solid-liquid separation was performed with a filter to give fine polymer particles. Redispersion of the fine polymer particles in water and solid-liquid separation were repeated until compounds of phosphoric acid and calcium including calcium phosphate were sufficiently removed. Then fine polymer particles finally subjected to solid-liquid separation were sufficiently dried with a dryer to give base toner particles (4).

External addition the same as that in the production example of toner (1) was performed for base toner particles (4), thereby yielding toner (4).

### Production Example of Toner (5)

Toner (5) was produced as in the production example of toner (4), except that water-insoluble dye compound (25) was used in place of water-insoluble dye compound (8).

### Production Example of Toner (6)

Toner (6) was produced as in the production example of toner (5), except that 1.2 parts of 1-butanol was added to the masterbatch.

### Production Example of Toner (7)

First, 100 parts of a binder resin (polyester resin, Tg: 55° C., acid value: 20 mg KOH/g, hydroxyl value: 16 mg KOH/g, molecular weight: Mp4 500, Mn: 2,300, Mw: 38,000), 5 parts of water-insoluble dye compound (23), 0.5 parts of an aluminum 3,5-di-tert-butylsalicylate compound, and 5 parts of paraffin wax (temperature of the maximum endothermic peak: 78° C.) were well mixed together using a Henschel mixer (Model: FM-75J, manufactured by Mitsui Mining Co., Ltd). The mixture was kneaded with a twin-screw kneader (Model: PCM-45, manufactured by Ikegai Ironworks Corp.) set at 130° C. and a feed rate of 60 kg/hr (the temperature of the kneaded mixture was about 150° C. at the time of ejection). The kneaded mixture was cooled, coarsely ground with a hammer mill, and finely pulverized with a mechanical mill (T-250, manufactured by Turbo Kogyo Co., Ltd.) at a feed rate of 20 kg/hr.

The resulting pulverized toner particles were classified by a multi-division classifier utilizing the Coanda effect, thereby yielding base toner particles (7).

External addition the same as that in the production example of toner (1) was performed for base toner particles (7), thereby yielding toner (7).

### Measurement

Physical properties of the resulting toners were measured as described below.

### Weight-Average Particle Diameter D4 and Number-Average Particle Diameter D1 of Toner

The number-average particle diameter (D1) and the weight-average particle diameter (D4) of the foregoing toner particles were measured by a particle size distribution analysis according to the Coulter method. Measurement was performed with Coulter Counter TA-II or Coulter MultiSizer II (manufactured by Beckman Coulter, Inc.) serving as a measuring apparatus according to the operation manual of he apparatus. An aqueous solution of about 1% sodium chloride may be used as an electrolytic solution, the aqueous solution being prepared from first grade sodium chloride. For example, ISOTON-II (manufactured by Beckman Coulter, Inc.) is commercially available and may be used. A specific measurement method is as follows: First, 0.1 to 5 mL of a surfactant (e.g., alkylbenzene sulfonate) is added as a dispersant to 100 to 150 mL of the electrolytic solution. Then 2 to 20 mg of a measurement sample (toner) is added thereto. The electrolytic solution containing the suspended sample is subjected to dispersion treatment with an ultrasonic disperser for about 1 to about 3 minutes. The volume and number of the toner particles each having a size of 2.00 μm or more in the resulting dispersion are measured with the measuring apparatus equipped with a 100-μm aperture to calculate a volume distribution and a number distribution of the toner particles. Then the number-average particle diameter (D1), the weight-average particle diameter (D4) (a median of each channel is taken as a representative value of each channel), and D4/D1 are determined.

As the foregoing channels, the following 13 channels are used: 2.00 to 2.52 μm, 2.52 to 3.17 μm, 3.17 to 4.00 μm, 4.00 to 5.04 μm, 5.04 to 6.35 μm, 6.35 to 8.00 μm, 8.00 to 10.08 μm, 10.08 to 12.70 μm, 12.70 to 16.00 μm, 16.00 to 20.20 μm, 20.20 to 25.40 μm, 25.40 to 32.00 μm, and 32.00 to 40.30 μm.

### Measurement of Average Circularity of Toner

Measurement was performed with a flow-type particle image analyzer “FPIA-2100” (manufactured by Sysmex Corporation). The average circularity was calculated from expressions described below.

$$\begin{matrix}Circle - equivalent diameter = \sqrt{projected area of particle / π} \times 2 & [ Math . 1 ] \\ Circularity = \frac{ \begin{matrix}circumferential length of circle with \\ area equal to projected area of particle\end{matrix}}{\begin{matrix}circumferential length of projected \\ image of particle\end{matrix}} & [ Math . 2 ]\end{matrix}$$

Here, the term “projected area of particle” is defined as the area of a binarized image of a toner particle. The term “circumferential length of projected image of particle” is defined as the length of a contour line obtained by connecting edge points of the image of the toner particle. The circularity serves as an index to the degree of irregularities of a particle. The circularity indicates 1.000 when the particle has a completely spherical shape. An increase in the complexity of the surface shape reduces the circularity.

### Evaluation

The magenta toners were evaluated as described below. Table 2 illustrates the evaluation results.

### Evaluation of Lightness and Saturation of Image Sample

Image samples were formed using the resulting toners. The lightness and saturation of the samples were evaluated. To compare image characteristics, an image output test was made using a modified apparatus of LBP-5300 (manufactured by CANON KABUSHIKI KAISHA) as an image forming apparatus. The modification was performed in such a manner that a developing blade in a process cartridge was replaced with a stainless blade having a thickness of 8 μm and that a blade bias of −200 V against a developing bias that was applied to a developing roller serving as a toner support was applicable.

With respect to each of the resulting image samples, chromaticity (L*, a*, b*) in the L*a*b* color system was measured with a reflection densitometer (Model: SpectroLino, manufactured by GretagMacbeth).

In the L*a*b* space, color coordinates indicating the magenta color of the Japan Color 2001 are defined as X (L₁, a₁, b₁). In the L*a*b* space, coordinates of an intersection point of a plane including the L* axis and the coordinates X and the a*b* curve of the image sample obtained by the chromaticity measurement are defined as Y (L₂, a₂, b₂). The a*b* curve is obtained by forming a plurality of image samples having different toner adhesion amounts. The difference Δc (=c₂−c₁) between a c* value [=c₂={(a₂²+b₂²)}^{1/2}] at the intersection point Y and a c* value [=c₁={(a₁²+b₁²)}^{1/2}] at the coordinates X was calculated. The difference ΔL (=L₂−L₁) between an L* value (=L₂) at the intersection point Y and an L* value (=L₁) at the coordinates X was calculated.

The lightness and saturation were evaluated on the basis of the following evaluation criteria.

A: Δc is 0 or more, and ΔL is 0 or more;
B: Δc is −5 or more, and ΔL is −5 or more, excluding the case of Class A described above; and
C: Δc is less than −5, or ΔL is less than −5.

In the case where Δc was −5 or more and ΔL was −5 or more, the sample was evaluated to have satisfactory lightness and saturation.

### Evaluation of Lightfastness

The image samples were placed in Atlas Weather-Ometer Ci4000 (from Toyo Seiki Seisaku-sho, Ltd.) and exposed for 60 hours. In this case, measurement conditions were as follows: black panel temperature: 50° C., chamber temperature: 40° C., relative humidity: 70%, and irradiance: 0.39 W/m² (340 nm).

The chromaticity (L*, a*, b*) in the L*a*b* color system was measured with the reflection densitometer (Model: SpectroLino, manufactured by GretagMacbeth) before and after the exposure test. The color difference (ΔE) was calculated from the following expression on the basis of measurements of the color characteristics:

Color difference(ΔE)={(a*before test−a*after test)²+(b*before test−b*after test)²+(L*before test−L*after test)²}^{1/2}

In the case where ΔE was less than 10 after 60 hours, the sample was evaluated to have satisfactory lightfastness.

Table 2 illustrates the evaluation results of toners (1) to (7) according to aspects of the present invention and comparative toners (1) to (3) produced in the production examples.

TABLE 2
Evaluation result

| | | | | | | | | | | | Evaluation of | |
|---|---|---|---|---|---|---|---|---|---|---|---|---|
| | | | | | | | | | | | lightness and | ΔE |
| Toner | Compound | D50 | D4/D1 | Circularity | L* | a* | b* | c* | Δc | ΔL | saturation | (60 h) |
| (1) | (5) | 6.63 | 1.26 | 0.974 | 54.0 | 81.3 | −5.9 | 81.5 | 6.5 | 9.03 | A | 3.5 |
| (2) | (8) | 6.51 | 1.20 | 0.982 | 53.4 | 81.2 | −4.5 | 81.3 | 6.4 | 8.44 | A | 4.1 |
| (3) | (8) | 6.32 | 1.31 | 0.970 | 54.1 | 81.3 | −6.0 | 81.5 | 6.5 | 9.11 | A | 3.3 |
| (4) | (8) | 6.73 | 1.42 | 0.973 | 53.9 | 80.7 | −7.6 | 81.1 | 6.1 | 8.93 | A | 3.7 |
| (5) | (25) | 6.53 | 1.31 | 0.984 | 54.3 | 81.2 | −6.3 | 81.5 | 6.5 | 9.33 | A | 4.5 |
| (6) | (25) | 6.67 | 1.38 | 0.972 | 56.3 | 83.7 | −8.8 | 84.2 | 9.2 | 11.33 | A | 5.5 |
| (7) | (23) | 6.26 | 1.44 | 0.989 | 55.6 | 83.0 | −8.2 | 83.4 | 8.4 | 10.63 | A | 6.5 |
| Comparative | Comparable | 6.71 | 1.18 | 0.966 | 92.2 | 11.6 | −0.9 | 11.6 | −63.4 | 47.20 | C | 18.2 |
| toner (1) | compound (1) | | | | | | | | | | | |
| Comparative | Comparable | 9.22 | 1.53 | 0.920 | 19.8 | 47.2 | −2.4 | 47.3 | −27.7 | −25.18 | C | 9.6 |
| toner (2) | compound (2) | | | | | | | | | | | |
| Comparative | Comparable | 6.88 | 1.43 | 0.965 | 57.1 | 63.4 | −3.2 | 63.5 | −11.5 | 12.13 | C | 2.5 |
| toner (3) | compound (3) | | | | | | | | | | | |

As illustrated in Table 2, in the toner using comparative compound 1, although the lightness is satisfactory, a good balance between the saturation and lightfastness is not provided. In each of the toners using comparative compounds 2 and 3, although the lightfastness is satisfactory, the lightness and saturation are not sufficient. In contrast, each of the toners produced by using the dye compounds represented by formula (1) has a good balance between spectral reflection characteristics, such as high lightness and saturation, and high lightfastness.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-059554, filed Mar. 17, 2011, which is hereby incorporated by reference herein in its entirety.

### INDUSTRIAL APPLICABILITY

Aspects of the present invention provide a magenta toner having spectral reflection characteristics, such as high color developability and transparency, and high lightfastness. The magenta toner according to aspects of the present invention is used for image forming apparatuses using electrophotography, toner displays used for electronic paper, and as a toner used to form a circuit pattern by digital fabrication.

1. A magenta toner comprising:
a water-insoluble dye compound represented by formula (1); and
a binder resin: 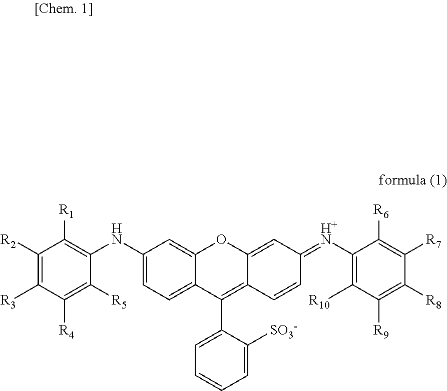
[wherein in formula (1), R₁, R₅, R₆, and R₁₀ each independently represent an alkyl group; R₃ and R₈ each independently represent a hydrogen atom, an alkyl group, an alkoxy group, or an aryloxy group; and R₂, R₄, R₇, and R₉ each independently represent a hydrogen atom or an acylamino group represented by formula (2), provided that at least one of R₂, R₄, R₇, and R₉ represents an acylamino group represented by formula (2): 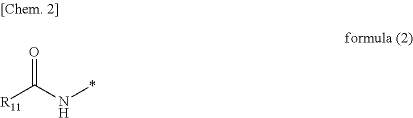
(wherein in formula (2), R₁₁ represents an alkyl group, a cycloalkyl group, an aryl group, an arylalkyl group, an alkenyl group, or a heterocyclic group; and * represents a binding site)].

2. The magenta toner according to claim 1, wherein R₁₁ in formula (2) represents an alkyl group or an aryl group.

3. The magenta toner according to claim 1, wherein R₁₁ in formula (2) represents a linear alkyl group.

4. The magenta toner according to claim 1, wherein in formula (1), R₁ and R₆ represent the same substituent, R₂ and R₇ represent the same substituent, R₃ and R₈ represent the same substituent, R₄ and R₉ represent the same substituent, and R₅ and R₁₀ represent the same substituent.

5. The magenta toner according to claim 1, wherein the magenta toner includes
base toner particles, each of which contains a binder resin, wax, and a colorant, and
an external additive located on surfaces of the base toner particles.

6. The magenta toner according to claim 5, wherein the base toner particles are produced by a suspension polymerization method.

7. The magenta toner according to claim 5, wherein the base toner particles are produced by an emulsion aggregation method.
